(19) United States
(12) Patent Application Publication
(10) Pub. No.: US 2026/0368623 A1
(43) Pub. Date: Nov. 19, 2026

(54) Training or Controlling Sequence Processing Models to Generate Outputs Indicative of Model Abilities

(71) Applicant: GDM Holding LLC, Mountain View, CA (US)

(72) Inventors: Sian Heather Gooding, London (GB); Florian Nils Hartmann, Zurich (CH)

(21) Appl. No.: 19/209,447

(22) Filed: May 15, 2025

(51) Int. Cl. G06N 20/00

(52) U.S. Cl. CPC G06N 20/00

(57) ABSTRACT

Example embodiments of the present disclosure provide an example method for managing computer systems and networks that perform showcasing of large language learning model capabilities. The systems can train various types of machine-learned models to manage capabilities and information associated therewith. The training machine-learned models can generate training data utilized to train other machine-learned models (e.g., machine-learned sequence processing models), including sequence processing models (LLMs) and vision language models (VLMs), to handle capability discovery problems.

### FIELD

The present disclosure relates generally to machine learning processes and machine-learned devices and systems. More particularly, the present disclosure relates to improved generation of training data utilized for showcasing sequence processing model capabilities.

### BACKGROUND

Training data used to train machine-learned models can include synthetic data that includes machine-learned model generated training data. The synthetic data may be used to train the machine-learned models in various ways. The synthetic data may be used to train the trained machine-learned model to perform various operations, such understanding, processing, and/or generating different types of information.

The trained machine-learned models can perform various tasks and solve various problems. The trained machine-learned models can have various capabilities for performing operations in response to input, such as natural language requests and/or natural language commands received from users. The users can request the trained machine-learned models to perform various tasks. The tasks can be performed to generate information and/or data to be output from the machine-learned models. The information and/or data can be output by the machine-learned models in various ways.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining, by a computing system may include one or more computing devices, a training example for training a machine-learned sequence processing model. The method also includes training, by the computing system using the training example, the machine-learned sequence processing model to generate a model output that references one or more capabilities of the machine-learned sequence processing model. The method also includes providing, by the computing system, the machine-learned sequence processing model as an output.

The computer-implemented method may include storing, by the computing system, a list of pre-determined external services; and automatically constructing, by the computing system, the training example from an initial example output. Automatically constructing the training example may include detecting, by the computing system, that the initial example output mentions one of the pre-determined external services; and in response to said detecting, adding, by the computing system, additional content to the initial example output that references the one or more capabilities of the machine-learned sequence processing model relative to the one of the pre-determined external services.

The computer-implemented method may include storing, by the computing system, a hierarchical representation of a plurality of different tasks; and automatically constructing, by the computing system, the training example from an initial example output. Automatically constructing the training example may include detecting, by the computing system, that the initial example output mentions one of the plurality of different tasks; and in response to said detecting, adding, by the computing system, additional content to the initial example output that references the one or more capabilities of the machine-learned sequence processing model relative to a different task that is hierarchically related to the one of the tasks mentioned in the initial example output.

The computer-implemented method may include storing, by the computing system and for one or more tasks, one or both of a set of preferred input data features or a dataset of few-shot examples having the preferred input data features; and automatically constructing, by the computing system, the training example from an initial example output. Automatically constructing the training example may include detecting, by the computing system, that the initial example output mentions or performs the one or more tasks; and in response to said detecting, adding, by the computing system, additional content to the initial example output that references the one or more capabilities of the machine-learned sequence processing model relative to the preferred input data features.

The training example may include a training input and a ground truth training output, where the ground truth training output references the one or more capabilities of the machine-learned sequence processing model, and where training, by the computing system using the training example, the machine-learned sequence processing model may include performing, by the computing system, supervised learning on the training example.

Training, by the computing system using the training example, the machine-learned sequence processing model may include training, by the computing system, a reward model to generate a positive reward value for model outputs that reference the one or more capabilities of the machine-learned sequence processing model; and performing, by the computing system, reinforcement learning on the machine-learned sequence processing model using the reward model.

Training, by the computing system, the reward model may include training, by the computing system, the reward model on human feedback data that indicates a preference for model outputs that reference the one or more capabilities of the machine-learned sequence processing model.

The computer-implemented method may include processing, by the computing system, an input with the machine-learned sequence processing model to generate an additional output that references the one or more capabilities of the machine-learned sequence processing model; observing, by the computing system, a user interaction with the additional output; and further training, by the computing system, the machine-learned sequence processing model based on the user interaction.

The computer-implemented method may include identifying user-specific data associated with a plurality of users. Training, by the computing system using the training example, the machine-learned sequence processing model may include training, by the computing system using the training example, the machine-learned sequence processing model to generate the model output that references the one or more capabilities of the machine-learned sequence processing model corresponding to individual ones of the plurality of users.

Example aspects of the present disclosure provide an example computing system that includes one or more processors; and one or more non-transitory computer-readable media that store instructions that, when executed by the one or more processors, cause the computing system to perform operations, the operations including processing, by the computing system, an input with a machine-learned sequence processing model to generate an initial model output. The operations may also include determining, by the computing system, whether to modify the initial model output. The operations may also include in response to a determination to modify the initial model output, modifying, by the computing system, the initial model output to include one or more references to one or more capabilities of the machine-learned sequence processing model.

The computing system where determining, by the computing system, whether to modify the initial model output may include detecting, by the computing system, that the initial model output mentions one of a number of pre-determined external services; and in response to said detecting, adding, by the computing system, additional content to the initial model output that references the one or more capabilities of the machine-learned sequence processing model relative to the one of the pre-determined external services.

The computing system where determining, by the computing system, whether to modify the initial model output may include detecting, by the computing system, that the initial model output mentions one of a plurality of different tasks; and in response to said detecting, adding, by the computing system, additional content to the initial model output that references the one or more capabilities of the machine-learned sequence processing model relative to a different task that is hierarchically related to the one of the tasks mentioned in the initial model output.

The computing system where determining, by the computing system, whether to modify the initial model output may include detecting, by the computing system, that the initial model output mentions one or more tasks; and in response to said detecting, adding, by the computing system, additional content to the initial model output that references the one or more capabilities of the machine-learned sequence processing model relative to one or more preferred input data features.

The computing system, where the operations may include, identifying user-specific data associated with a plurality of users, and training, by the computing system using a training example, the machine-learned sequence processing model to generate the initial model output that references the one or more capabilities of the machine-learned sequence processing model corresponding to individual ones of the plurality of users

Example aspects of the present disclosure provide one or more non-transitory computer readable media storing instructions that are executable by one or more processors to perform operations. The operations may include obtaining, by a computing system may include one or more computing devices, a training example for training the machine-learned sequence processing model. The operations may also include training, by the computing system using the training example, the machine-learned sequence processing model to generate a model output that references one or more capabilities of the machine-learned sequence processing model. The operations may also include storing, by the computing system, the machine-learned sequence processing model.

The one or more non-transitory computer-readable media, where the operations may include storing, by the computing system, a list of pre-determined external services; automatically constructing, by the computing system, the training example from an initial example output, where automatically constructing the training example may include detecting, by the computing system, that the initial example output mentions one of the pre-determined external services; and in response to said detecting, adding, by the computing system, additional content to the initial example output that references the one or more capabilities of the machine-learned sequence processing model relative to the one of the pre-determined external services.

The one or more non-transitory computer-readable media, where the operations may include storing, by the computing system, a hierarchical representation of a plurality of different tasks; and automatically constructing, by the computing system, the training example from an initial example output. Automatically constructing the training example may include detecting, by the computing system, that the initial example output mentions one of the plurality of different tasks; and in response to said detecting, adding, by the computing system, additional content to the initial example output that references the one or more capabilities of the machine-learned sequence processing model relative to a different task that is hierarchically related to the one of the tasks mentioned in the initial example output.

The one or more non-transitory computer-readable media, where the operations may include storing, by the computing system and for one or more tasks, one or both of a set of preferred input data features or a dataset of few-shot examples having the preferred input data features; and automatically constructing, by the computing system, the training example from an initial example output. Automatically constructing the training example may include detecting, by the computing system, that the initial example output mentions or performs the one or more tasks; and in response to said detecting, adding, by the computing system, additional content to the initial example output that references the preferred input data features.

The one or more non-transitory computer-readable media, where the training example may include a training input and a ground truth training output, where the ground truth training output references the one or more capabilities of the machine-learned sequence processing model, and where training, by the computing system using the training example, the machine-learned sequence processing model may include performing, by the computing system, supervised learning on the training example.

The one or more non-transitory computer-readable media, where training, by the computing system using the training example, the machine-learned sequence processing model may include training, by the computing system, a reward model to generate a positive reward value for model outputs that reference the one or more capabilities of the machine-learned sequence processing model; and performing, by the computing system, reinforcement learning on the machine-learned sequence processing model using the reward model.

Example aspects of the present disclosure provide an example method. In some implementations, the example method can include obtaining, by a computing system may include one or more computing devices, an input may include a natural language inquiry. The method may also include analyzing, by the computing system, the natural language inquiry with a machine-learned model to output content based on the natural language inquiry. The method may also include analyzing, by the computing system, the content with the machine-learned model to output a trigger to showcase a capability of the machine-learned model, the content being interpreted as a catalyst to generate the trigger, the catalyst may include an explicit catalyst associated with a focus of the content being showcasing or an implicit catalyst associated with the focus not being showcasing. The method may also include processing, by the computing system, the trigger with the machine-learned model to evoke an automated tutorial associated with a characteristic of the machine-learned model derived from deconstruction of the content. The method may also include causing, by the computing system, presentation with a computing device of the automated tutorial.

The computer-implemented method may also include analyzing, by the computing system, the content with the machine-learned model to identify a category associated with the content, the category may include at least one of a first category associated with an external service identified in the content, a second category associated with a task of a level being below a level threshold, or a third category associated with information provided in the content not satisfying a requirement of an action associated with the catalyst.

The computer-implemented method, where the explicit catalyst may include a command or an inquiry associated with at least one of the automated tutorial or the capability of the machine-learned model. The computer-implemented method, where the implicit catalyst may include a command or an inquiry not associated with any automated tutorial or any capability of the machine-learned model.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example block diagram depicting machine-learning showcasing-related operations, including training showcasing operations, showcasing operations, and showcasing aggregator operations, according to example embodiments of the present disclosure;

FIG. 2 depicts an example block diagram depicting operations associated with various showcasing components, according to example embodiments of the present disclosure;

FIG. 3 depicts an environment including one or more systems for performance of training showcasing operations and showcasing operations, according to example embodiments of the present disclosure;

FIG. 4 is a flow chart diagram illustrating an example method for training showcasing operations, according to example implementations of aspects of the present disclosure;

FIG. 5 is a flow chart diagram illustrating an example method for showcasing operations, according to example implementations of aspects of the present disclosure;

FIG. 6 is a flow chart diagram illustrating an example method for showcasing operations, according to example implementations of aspects of the present disclosure;

FIG. 7 is a flow chart diagram illustrating an example method for training a machine-learned model according to example implementations of aspects of the present disclosure;

FIG. 8 is a block diagram of an example processing flow for using machine-learned model(s) to process input(s) to generate output(s) according to example implementations of aspects of the present disclosure;

FIG. 9 is a block diagram of an example sequence processing model according to example implementations of aspects of the present disclosure;

FIG. 10 is a block diagram of an example technique for populating an example input sequence for processing by a sequence processing model according to example implementations of aspects of the present disclosure;

FIG. 11 is a block diagram of an example model development platform according to example implementations of aspects of the present disclosure;

FIG. 12 is a block diagram of an example training workflow for training a machine-learned model according to example implementations of aspects of the present disclosure;

FIG. 13 is a block diagram of an inference system for operating one or more machine-learned model(s) to perform inference according to example implementations of aspects of the present disclosure;

FIG. 14 is a block diagram of an example networked computing system according to example implementations of aspects of the present disclosure;

FIG. 15 is a block diagram of an example computing device according to example implementations of aspects of the present disclosure; and

FIG. 16 is a block diagram of an example computing device according to example implementations of aspects of the present disclosure.

### DETAILED DESCRIPTION

Generally, the present disclosure is directed to computer-implemented systems and methods that train and/or control various types of machine-learned models to generate outputs that demonstrate model capabilities and/or information associated therewith. Training machine-learned models can include generating training data utilized to train machine-learned models (e.g., machine-learned sequence processing models), including large language models (LLMs) and vision language models (VLMs), to handle capability discovery problems. The machine-learned models trained with solutions to handle the capability discovery problems can include various types of machine-learned models that receive input, including natural language text, natural language utterances (e.g., verbal utterances), and/or vision. The machine-learned models receiving training data to achieve the capability discovery solutions can be improved by enabling the trained machine-learned models to handle, and in some cases anticipate and/or prevent, occurrences of the capability discovery problems.

The machine-learned models can be trained to showcase services of the trained machine-learned models according to a first category related to services being interchangeable with external services requested by users. The machine-learned models can be trained using initial example outputs based on lists of pre-determined external services. The machine-learned models can be trained to identify the requested external services and to perform showcase operations related to services available via the machine-learned models. By training the machine-learned models to showcase the available services, the machine-learned models can enable users to become informed about the available services based on the users receiving prompts regarding the showcasing and the users requesting the showcasing.

The machine-learned models can be trained to showcase services of the trained machine-learned models according to a second category related to services usable for performing tasks of higher-levels than tasks related to requests from users. The machine-learned models can be trained using initial example outputs based on hierarchical representations of different tasks. The machine-learned models can be trained to showcase the services that the trained machine-learned models can provide to enable relatively higher-level tasks to be performed notwithstanding the users being potentially initially unaware of the capabilities of the machine-learned models for performing operations related to the higher-level tasks. The trained machine-learned models can showcase the services associated with the higher-level tasks based on the trained machine-learned models receiving the requests related to relatively lower-level tasks and the trained machine-learned models determining, in response to receiving the requests, to showcase the services associated with the higher-level tasks.

The machine-learned models can be trained to showcase services of the trained machine-learned models according to a third category related to services being usable for performing operations based on partial information not being initially provided in requests by users. The machine-learned models can be trained using initial example outputs based on one or both of i) sets of preferred input data features or ii) datasets of few-shot examples having the preferred input data features. The trained machine-learned models can analyze requests from users omitting partial information required for performing the operations. The machine-learned models can be trained to identify that the requests are missing the partial information and to showcase capabilities of the machine-learned models to enable users to submit additional requests with the partial information.

Increasing sophistication levels of knowledge bases of users of machine-learned models can result in higher levels of utilization of the machine-learned models. However, continually expanding collections of diverse and/or varied capabilities of machine-learned models create difficulties for users, even users with high levels of sophistication, in staying up to date with regard to their knowledge, understanding, and/or awareness of the capabilities. While users are generally becoming increasingly competent and have growing levels of comfort and familiarity with capabilities of machine-learned models, widespread expansion of utilization of machine-learned models can pose ever evolving challenges to users.

User familiarity, awareness, and comfort with machine-learned model capabilities have significant implications for efficiency and effectiveness of utilization of machine-learned models. However, current machine-learned models may be unable to identify gaps in understanding of users attempting to utilize machine-learned models for various purposes. Lack of user awareness of capabilities of machine-learned models according to the first category for performing services that are interchangeable with external services may prevent the machine-learned models from being utilized to perform the interchangeable services. Lack of user awareness of capabilities of machine-learned models according to the second category for performing services of high-level tasks may limit the machine-learned models to being utilized to perform only low-level tasks requested by the users. Lack of user awareness of capabilities of machine-learned models according to the third category for performing services based on subsequent submission of additional information may limit existing machine-learned models to being utilized to perform only services based on initially provided partially inadequate information.

Increasing diversity and/or expansion of available capabilities of machine-learned models can create difficulties for users, even for users with high levels of sophistication, in staying up to date with regard to the knowledge and/or awareness of machine-learned model capabilities. While users are generally becoming increasingly competent and have growing levels of comfort and familiarity with capabilities of machine-learned models, widespread expansion of utilization of machine-learned models can still pose challenges to users

Machine-learned models, such as LLMs and vision language models (VLMs), operating according to conventional technology may receive training related to various tasks performed by the LLMs/VLMs but not related to how users can learn to use the tasks. Existing LLMs/VLMs may not receive training related to performing tasks used to educate users about capabilities of the LLMs/VLMs. Insufficient training of the LLMs/VLMs may include the LLMs/VLMs not being trained to identify possible absences of understanding of users regarding the LLM/VLM capabilities. Existing LLMs/VLMs may be untrained regarding how to identify and address the absences of user understanding. Paradoxical circumstances may be created based on i) a lack of training of the LLMs/VLMs for being able to inform users about their insufficient understanding of LLM capabilities, and ii) a lack of awareness of users regarding omissions of their requests for pertinent information from the LLMs/VLMs.

Users with insufficient understanding of the capabilities of LLMs/VLMs in conventional systems may be unable to identify existences of the insufficient understanding. Existing LLMs/VLMs being undertrained may result in users being unable to learn how to obtain such understanding. The lack of user understanding of the LLM/VLMs capabilities may persist due to users being informed regarding possibilities that may be available to learn how to more efficiently and/or satisfactorily use the LLMs/VLMs. The lack of user understanding may result in underutilization of the LLM capabilities. The lack of user understanding may result in relatively greater times required for the LLMs/VLMs to perform tasks, relatively lower levels of efficiency and/or effectiveness of services provided via performance of corresponding operations, and/or relatively less successful completion of tasks for which the operations of the LLMs/VLMs are performed.

Machine-learned models being trained utilizing the showcase training data may circumvent the above-mentioned drawbacks and/or failures of the machine-learned models implemented according to conventional technology. Machine-learned models trained utilizing the showcase training data may enable the machine-learned models to showcase information pertaining to the categories as discussed above, and to perform subsequent operations corresponding thereto.

Training machine-learned models to showcase capabilities of machine-learned models according to the techniques discussed herein increases likelihoods of users requesting performance by the machine-learned models of services and/or operations in contrast to services and/or operations that may otherwise be performed less efficiently and/or effectively elsewhere. By training the machine-learned models to perform the services and/or operations, compute, memory, and/or network resources that would otherwise be consumed may be conserved. The machine-learned models being trained to showcase capabilities may be utilized to perform more optimal services and/or operations based on the machine-learned models being trained to be more knowledgeable regarding deficiencies associated with user requests. Performance of the services and/or operations that may otherwise have occurred by other models may be achieved more efficiently and/or effectively using the machine-learned models that are trained based on the showcasing training data.

Training the machine-learned models according to the techniques discussed herein to perform the services and/or operations associated with the categories as explained above allows the machine-learned models to be trained to showcase the capabilities whenever this could be helpful to the user. Training of the machine-learned models can also be performed by aggregating information across queries of any individual users, information across queries that may be redundant or extraneous, and/or information across queries that may be utilized to continually improve the machine-learned models. The aggregated information can be utilized to train the machine-learned models to showcase capabilities based on expertise of individual users.

Training the machine-learned models according to the techniques discussed herein can include the machine-learned models being trained to identify tasks that may be recommended by the trained machine-learned models. Training the machine-learned models can include the machine-learned models being trained to suggest certain tasks based on identifications of absences of requests from users for information about the tasks. Alternatively or additionally, training the machine-learned models can include the machine-learned models being trained to suggest certain tasks based on percentage thresholds corresponding to how often the machine-learned models are trained to suggest the tasks. Such techniques may reduce overall consumption of resources due to training of the machine-learned models being used to reduce redundant and/or unnecessary showcasing and/or to minimize performance of antiquated or less efficient operations.

Training the machine-learned models according to the techniques discussed herein can include the machine-learned models being trained to use showcasing requests, and/or lack thereof, as feedback signals. The machine-learned models can be trained to utilize the feedback signals to perform, or not perform, showcasing for future scenarios with similar circumstances. The machine-learned models can be trained to fine-tune showcasing capabilities and/or hyperparameters on the feedback signals. Alternatively or additionally, the machine-learned models can be trained to use the feedback signals as metrics to evaluate effectiveness of showcasing operations.

Training the machine-learned models with showcasing according to the techniques discussed herein can enable performance of operations in answer to queries to be performed faster and/or more easily, thereby reducing loads on compute, memory, and/or network resources. Training the machine-learned models with showcasing operations can reduce installations of applications required by users, including installations of special purpose and/or customized applications. Training the machine-learned models with showcasing operations can reduce redundant and/or duplicate operations that may otherwise be performed for users without knowledge of capabilities.

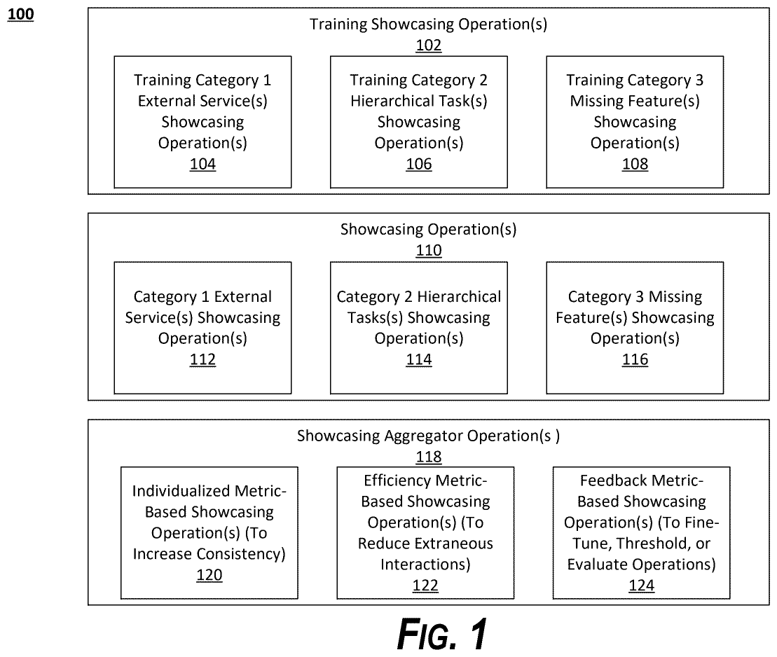

FIG. 1 depicts an example block diagram depicting machine-learning showcasing-related operations 100, including training showcasing operations, showcasing operations, and showcasing aggregator operations, according to example embodiments of the present disclosure. The operations 100 can be performed by one or more computing systems. For instance, a computing system that includes one or more computing devices can be utilized to perform the operations 100. The training showcasing operations can include one or more training showcasing operations 102.

The training showcasing operation(s) 102 can be generated by one or more machine-learned models and utilized to train one or more other machine-learned models. The training machine-learned model(s) can generate a training example used to train the other machine-learned model(s). The machine-learned model(s) being trained can include, in some examples, one or more machine-learned sequence processing models. For instance, a machine-learned sequence processing model can be trained based on the training example.

The machine-learned sequence processing model can be trained to perform various operations associated with one or more capabilities of the machine-learned sequence processing model. For example, the training machine-learned model(s) can generate the training example to train the machine-learned sequence processing model to generate a model output that references the capability(ies) of the machine-learned sequence processing model. The model output can be utilized to train the machine-learned sequence processing model. The trained machine-learned sequence processing model can be provided as an output. The output machine-learned sequence processing model can be utilized to perform various showcasing operations.

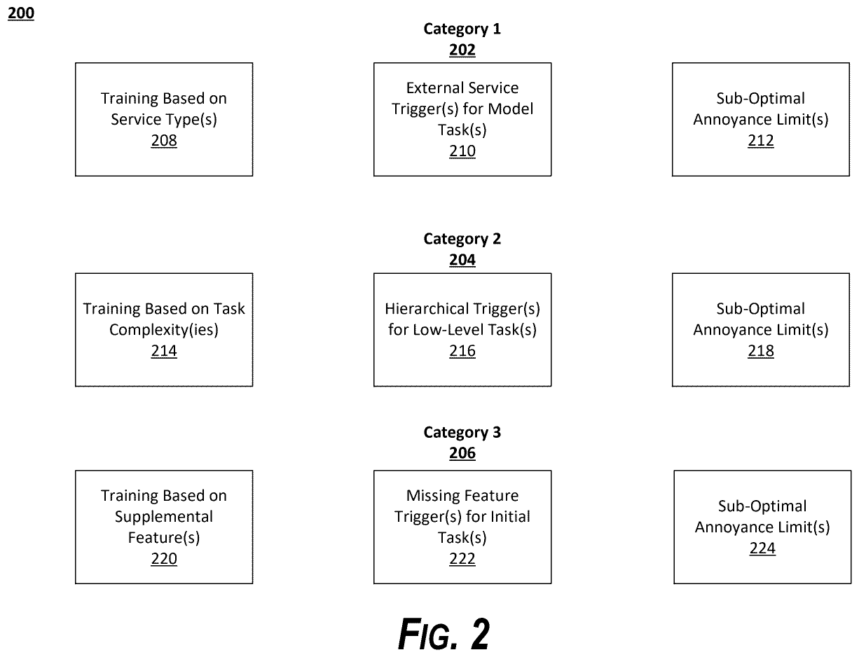

For example, the trained machine-learned sequence processing model can perform various operations (e.g., the showcasing operation(s) 110, as discussed below in further detail) utilized to showcase the capability(ies) according to one or more categories of operations and/or capabilities. A first category (e.g., the category 1 202, as discussed below with reference to FIG. 2, in further detail) can be associated with services being interchangeable with external services that may be requested by users. A second category (e.g., the category 2 204, as discussed below with reference to FIG. 2, in further detail) may be associated with services usable for performing tasks of higher-levels than tasks that may be requested by users. A third category (e.g., the category 3 206, as discussed below with reference to FIG. 2, in further detail) may be associated with services being usable for performing operations based on partial information not being initially provided in requests that may be received from users.

The training showcasing operation(s) 102 can include one or more training showcasing operations (or “training category 1 external service(s) showcasing operation(s),” or “training external service(s) showcasing operation(s),” or “training showcasing operation(s)”) 104 associated with a training category 1. The training showcasing operation(s) 104 (e.g., the training 208, as discussed below with reference to FIG. 2) can be generated via the training machine-learned model(s) and/or utilized to train the machine-learned sequence processing model. One or more training external services associated with the training category 1 may be referenced, implicitly or explicitly, and/or identified based on, one or more training requests (e.g., one or more training examples). The training external service(s) can be identified based on the training request(s) and utilized to identify the training external service(s) showcasing operation(s) 104.

The training showcasing operation(s) 102 can include one or more training showcasing operations (or “training category 2 hierarchical task(s) showcasing operation(s),” or “training hierarchical task(s) showcasing operation(s),” or “training showcasing operation(s)”) 106 associated with a training category 2. The training showcasing operation(s) 106 (e.g., the training 214, as discussed below with reference to FIG. 2) can be generated via the training machine-learned model(s) and/or utilized to train the machine-learned sequence processing model. One or more training hierarchical tasks associated with the training category 2 may be referenced, implicitly or explicitly, and/or identified based on, one or more training requests. The training hierarchical task(s) can be identified based on the training request(s) and utilized to identify the training hierarchical task(s) showcasing operation(s)

The training showcasing operation(s) 102 can include one or more training showcasing operations (or “training category 3 missing feature(s) showcasing operation(s),” or “training missing feature(s) showcasing operation(s),” or “training showcasing operation(s)”) 108 associated with a training category 3. The training showcasing operation(s) 108 (e.g., the training 220, as discussed below with reference to FIG. 2) can be generated via the training machine-learned model(s) and/or utilized to train the machine-learned sequence processing model. One or more training missing features associated with the training category 3 may be referenced, implicitly or explicitly, and/or identified based on, one or more training requests. The training missing feature(s) can be identified based on the training request(s) and utilized to identify the training missing feature(s) showcasing operation(s) 108.

The showcasing operations can include one or more showcasing operations 110. The showcasing operation(s) 110 can include one or more showcasing operations (or “category 1 external service(s) showcasing operation(s),” or “external service(s) showcasing operation(s),” or “showcasing operation(s)”) 112 associated with a category 1. The showcasing operation(s) 112 (e.g., the showcasing operation(s) performed utilizing, and/or based on, the trigger(s) 210, as discussed below with reference to FIG. 2) can be performed utilizing the trained machine-learned sequence processing model. One or more external services associated with the category 1 may be referenced, implicitly or explicitly, and/or identified based on, one or more user requests. The external service(s) can be identified based on the user request(s) and utilized to identify the external service(s) showcasing operation(s) 112.

The showcasing operation(s) 110 can include one or more showcasing operations (or “category 2 hierarchical task(s) showcasing operation(s),” or “hierarchical task(s) showcasing operation(s),” or “showcasing operation(s)”)) 114 associated with a category 2. The showcasing operation(s) 114 (e.g., the showcasing operation(s) performed utilizing, and/or based on, the trigger(s) 216, as discussed below with reference to FIG. 2) can be performed utilizing the trained machine-learned sequence processing model. One or more hierarchical tasks associated with the category 2 may be referenced, implicitly or explicitly, and/or identified based on, one or more user requests. The hierarchical task(s) can be identified based on the user request(s) and utilized to identify the hierarchical task(s) showcasing operation(s) 114.

The showcasing operation(s) 110 can include one or more showcasing operations (or “category 3 missing feature(s) showcasing operation(s),” or “missing feature(s) showcasing operation(s)”) 116 associated with a category 3. The showcasing operation(s) 116 (e.g., the showcasing operation(s) performed utilizing, and/or based on, the trigger(s) 222, as discussed below with reference to FIG. 2) can be performed utilizing the trained machine-learned sequence processing model. One or more missing features associated with the category 3 may be referenced, implicitly or explicitly, and/or identified based on, one or more user requests. The missing feature(s) can be identified based on the user request(s) and utilized to identify the missing feature(s) showcasing operation(s) 116.

The showcasing operations can include one or more showcasing aggregator operations 118. The showcasing aggregator operation(s) 118 can include one or more individualized metric-based showcasing operations (to increase consistency) 120. One or more individualized metrics may be referenced, implicitly or explicitly, and/or identified based on, one or more user requests. The individualized metric(s) be identified based on the user request(s) and utilized to identify the individualized metric-based showcasing operation(s) 120.

The individualized metric-based showcasing operation(s) 120 can be performed via, and/or based on, the showcasing operation(s) 112, 114, and/or 116. In various examples, any of the individualized metric(s) can be utilized as a training metric to train the machine-learned sequence processing model, via the training showcasing operation(s) 104, 106, and/or 108. For example, the individualized metric(s) can be utilized to train the machine-learned sequence processing model to optimize consistency between any of the operation(s) 112, 114, and/or 116 with respect to other others of the operation(s) 112, 114, and/or 116 of the same category. In such an example or another example, the individualized metric(s) can be utilized to train the machine-learned sequence processing model to optimize consistency between any of the operation(s) 112, 114, and/or 116 with respect to any others of the operation(s) 112, 114, and/or 116 of other categories.

The showcasing operations can include one or more showcasing aggregator operations 118. The showcasing aggregator operation(s) 118 can include one or more efficiency metric-based showcasing operations (to reduce extraneous interactions) 122. One or more efficiency metrics may be referenced, implicitly or explicitly, and/or identified based on, one or more user requests. The efficiency metric(s) be identified based on the user request(s) and utilized to identify the efficiency metric-based showcasing operation(s) 122.

The efficiency metric-based showcasing operation(s) 122 can be performed via, and/or based on, the showcasing operation(s) 112, 114, and/or 116. In various examples, any of the efficiency metric(s) can be utilized as a training metric to train the machine-learned sequence processing model, via the training showcasing operation(s) 104, 106, and/or 108. For example, the efficiency metric(s) can be utilized to train the machine-learned sequence processing model to optimize efficiency of the operation(s) 112, 114, and/or 116.

The showcasing operations can include one or more showcasing aggregator operations 118. The showcasing aggregator operation(s) 118 can include one or more feedback metric-based showcasing operations (to fine-tune, threshold, or evaluate operations) 124. One or more feedback metrics may be referenced, implicitly or explicitly, and/or identified based on, one or more user requests. The feedback metric(s) be identified based on the user request(s) and utilized to identify the feedback metric-based showcasing operation(s) 124. For example, the feedback metric(s) can be utilized to train the machine-learned sequence processing model to fine-tune, threshold, or evaluate any of the operation(s) 112, 114, and/or 116. In such an example or another example, the feedback metric(s) can be utilized to train the machine-learned sequence processing model to fine-tune one or more hyperparameters of any of the operation(s) 112, 114, and/or 116 based on one or more feedback signals (e.g., with one or more thresholds, such as to define how often to tell a user about a task/operation according to any category before not suggesting it further).

The feedback metric-based showcasing operation(s) 122 can be performed via, and/or based on, the showcasing operation(s) 112, 114, and/or 116. In various examples, any of the feedback metric(s) can be utilized as a training metric to train the machine-learned sequence processing model, via the training showcasing operation(s) 104, 106, and/or 108.

By way of a hypothetical example, training a model (e.g., an LLM) for any of categories 1, 2, and/or 3 enables the model to showcase its capabilities whenever this could be helpful to the user. Instead of just showcasing capabilities on a per query level, information across queries of a given user can be aggregated and utilized to then showcase the capabilities based on that user's expertise.

In the hypothetical example, for each user, the model can be utilized to identify which tasks the user previously queried the model for. The model can be utilized to identify which tasks were recommended by the model. The model can be trained with a threshold defining whether to suggest a certain task if the user did not previously ask about the task and was also not told by the model about the task. Alternatively or additionally, a threshold of how often the user is told about a task before not suggesting the task further can be defined.

In the hypothetical example, one or more thresholds (e.g., for suggesting a task, for determining how many times to suggest a task, etc., or any combination thereof) can be used as a feedback signal. For example, the feedback signal can be identified based on a task having been recommended and followed by a corresponding request from and the user, and/or based on a task having been recommended and not followed by a corresponding request from and the user. The feedback signal can be utilized as an indication that the recommendation was useful or not. The feedback signal can be utilized to fine-tune the model or to fine-tune any hyperparameters on the feedback signal. Alternatively or additionally to using the feedback signal, one or more metrics can be identified and/or utilized (e.g., based on the user response(s)) to evaluate the effectiveness of the threshold(s)/feedback signal(s).

In the hypothetical example, users can learn more about the model's capabilities, and may be thus able to faster and more easily answer future queries. Users can potentially learn about capabilities without needing to install additional apps. A service provider of the model can ensure that users are familiar with the latest improvements added to models.

FIG. 2 depicts an example block diagram depicting operations 200 associated with various showcasing components, according to example embodiments of the present disclosure. The operations 200 can be performed by one or more computing systems (e.g., the computing system(s) utilized to perform the operations 100, and/or one or more other computing systems). For instance, a computing system that includes one or more computing devices (e.g., the computing device(s) utilized to perform the operations 100, and/or one or more other computing devices) can be utilized to perform the operations 200. The operations 200 can include one or more training operations associated with various categories associated with showcasing machine-learned model capabilities.

The operations 200 can include one or more training operations associated with a category 1 202. Category 1 can be associated with showcasing of one or more services (e.g., one or more machine-learned sequence processing model services identified based on one or more external services identified in input).

Alternatively or additionally, the operations 200 can include one or more training operations associated with a category 2 204. Category 2 can be associated with one or more services associated with showcasing of one or more tasks associated with one or more levels (e.g., one or more relatively higher level tasks identified based on one or more relatively lower level tasks identified in input).

Alternatively or additionally, the operations 200 can include one or more training operations associated with a category 3 206. Category 3 can be associated with one or more services associated with showcasing of one or more tasks associated with one or more modifications (e.g., one or more modifications identified based on one or more missing features identified in input).

With reference to the category 1, various types of operations (e.g., various training operations and various operations of other types) in the operations 200 can be performed utilizing one or more machine-learned models. The training operation(s) associated with the category 1 202 can be utilized for training based on one or more service types 208. For example, the training based on service type(s) 208 can include training one or more machine-learned sequence processing models (e.g., the machine-learned sequence processing model(s), as discussed above with reference to FIG. 1) according to the category 1.

Various operations associated with various service types, with which the category 1 can be associated, can be identified and utilized to train the machine-learned sequence processing model(s). For instance, a machine-learned sequence processing model can be trained by one or more training machine-learned models utilizing training data associated with the category 1. The category 1, and/or the training data associated therewith, can include, and/or be identified based on, one or more training examples.

Various types of training examples, with which category 1 can be associated, identified, and/or utilized to train the machine-learned sequence processing model. For instance, a training example can be obtained for training the machine-learned sequence processing model. In such an instance or another instance, the training example may be associated with the category 1.

Various content of the training example may be associated with the category 1. One or more training categories may be associated with the training example. For example, a training category, such as the category 1, may be associated with content of the training example. The content associated with the category 1 in the training example may include one or more training service types.

Various training service types in the training example may be associated with the training category as the category 1. The training service type(s) in the training example can include one or more training service types capable of being utilized for training, alternatively or additionally to one or more training external services identified in the training example. In some examples, the training service type(s) can include one or more training services capable of being substituted for the training external service(s). In those or other examples, the training service type(s) can include one or more training services capable of being utilized to perform one or more training services (or “training internal service(s)”) that are similar to, the same as, equivalent to, etc., the training external service(s). For instance, the training services (e.g., one or more machine-learned model training services identified via the training machine-learned model(s)) can be utilized to train the machine-learned sequence processing model).

The computing system can manage (e.g., identify, determine, generate, modify, update, fine-tune, analyze, store, delete, transmit, output, etc.) the training machine-learned model service(s) based on the training external service(s) as one or more output training services. The training external service(s) associated with the training input (e.g., the training example) can be utilized to train the machine-learned sequence processing model.

In some examples, individual ones of the training machine-learned model service(s) may be associated with a corresponding training external service. For instance, a training machine-learned model service may be similar to a training external service. A similarity between the training machine-learned model service and the training external service may be associated with a training similarity score. The training similarity score being above a training similarity threshold may indicate a relatively greater similarity between the training machine-learned model service and the training external service. The training similarity score less than or equal to the training similarity threshold may indicate a relatively lower similarity between the training machine-learned model service and the training external service. The training similarity score can be utilized to train the machine-learned sequence processing model.

The training machine-learned model service(s), which may be associated with the training similarity score(s), may be associated with one or more training similarity metrics (also simply referred to herein as “training metric(s)”). The training metric(s) associated with the training machine-learned model service(s) and the training external service(s) can include various metrics of various types. Any of the training metric(s) can be utilized to identify, can correspond to, and/or can be associated with, a service (e.g., identified in machine-learned model output), a type of output of a service, a type of operation utilized to generate a type of output data and/or information, a type of any other operation, and so on, or any combination thereof. In some examples, the training similarity score(s), and/or one or more values thereof, can be identified based on a training metric. In those or other examples, the training similarity score(s), and/or one or more values thereof, can be identified based on a total, an average, a median, etc., or any combination thereof, of one or more relevant training metrics associated with output (e.g., and/or one or more machine-learned model service(s) identified therein).

The training machine-learned model(s) can train the machine-learned sequence processing model to identify one or more differences between the external service(s) and the machine-learned model service(s). The machine-learned model(s) can train the machine-learned sequence processing model to utilize the difference(s) to proceed in various ways, such as according to various settings and/or configurations of the machine-learned model(s).

The machine-learned model(s) can utilize the training similarity score(s), the training metric(s), and/or one or more training differences to train the machine-learned sequence processing model to determine whether to generate and/or provide output associated with the machine-learned model service(s). The training similarity score(s), the training metric(s), and/or the training difference(s) can be utilized to train the machine-learned sequence processing model to output one or more differences, and/or one or more identifies, data, and/or information thereof, along with output associated with the machine-learned model service(s). The training machine-learned model(s) can train the machine-learned sequence processing model to determine whether to generate output, whether to provide output, and/or whether to generate and/or provide the difference(s) along with the output, such as based on a corresponding setting and/or a corresponding configuration of machine-learned sequence processing model.

Various types of model output (or “training model output”) that reference various capabilities of the machine-learned sequence processing model can be generated for training purposes. For instance, the computing system (e.g., and/or the training machine-learned model(s) therein) can identify, for training of the machine-learned sequence processing model, the training model output, which can reference one or more capabilities (or “training capability(ies)”) of the machine-learned sequence processing model.

Various training triggers can be utilized to train the machine-learned sequence processing model to manage model output that references various training capabilities. Individual ones of one or more training triggers (or “training external service trigger(s)”) can be train the machine-learned sequence processing model to manage (e.g., generate, set, etc.) one or more triggers based on corresponding similarity score(s) being less than the threshold. The training machine-learned model(s) can train the machine-learned sequence processing model to determine whether to generate and/or provide model output based on identifying the trigger(s) having been generated, set, etc. The trigger(s) may correspond to external service(s) being identified, provided, referenced, etc., in input.

The training trigger(s), the training similarity score(s), the difference(s), and/or the training trigger(s) can be utilized to train the machine-learned sequence processing model to determine whether to generate and/or provide model output, such as output specifying the machine-learned model service(s). For example, the machine-learned sequence processing model can be trained to provide output specifying the machine-learned model service(s) based on one or more similarity scores (e.g., calculated based on one or more similarity metrics) being above a similarity threshold. In such an example or another example, the machine-learned sequence processing model can be trained to provide output specifying one or more differences between the machine-learned model service(s) and one or more external services referenced in input received to the machine-learned sequence processing model. However, in some cases, the machine-learned model service(s) may be identical to the external service(s) referenced in input, such as with respect to functionality, type of output, etc., or any combination thereof.

Various training limits can be utilized to train the machine-learned sequence processing model to manage (e.g., identify, determine, generate, modify, update, fine-tune, analyze, store, delete, transmit, output, etc.) model output. For example, one or more limits utilized to manage generate, process, etc., model output can include one or more sub-optimal annoyance limits (e.g., the limit(s) 212, 218, and/or 224, as discussed below with reference to FIG. 2).

One or more training sub-optimal annoyance limits can be utilized to train the machine-learned sequence processing model to increase usability, convenience, effectiveness, enjoyment, etc., or any combination thereof, of the machine-learned sequence processing model. One or more training sub-optimal annoyance limits can be utilized to train the machine-learned sequence processing model to manage (e.g., identify, determine, generate, modify, update, fine-tune, analyze, store, delete, transmit, output, etc.) output, such as with respect to whether to generate and/or modify output. The training sub-optimal annoyance limit(s) can be utilized to train the machine-learned sequence processing model to manage how much content to include in output, and/or how complex the content in the output is.

Unnecessary content can be omitted, removed, extracted, etc., from output in various ways and/or for various purposes. The training limit(s) can be utilized to train the machine-learned sequence processing model to manage one or more occurrences of output that are similar to one or more previous occurrences of output (e.g., as possibly identified via a similarity score). For example, the trained machine-learned sequence processing model can output a summary of any of the previous occurrence(s) of output, a more succinct version of any of the previous occurrence(s) of output, a smaller and/or simpler version of any of the previous occurrence(s) of output, etc., or any combination thereof. In some cases, smaller, simpler, and/or more succinct versions can be included in the output, such as for cases in which longer/more complete/more thorough versions of the output were previously generated. Output generated by the machine-learned sequence processing model utilizing, according to, and/or based on, the modified output may be more convenient, helpful, simpler, and/or beneficial to users.

In various examples, the training limit(s) can include one or more training thresholds utilized to train the machine-learned sequence processing model. For example, the machine-learned sequence processing model can be trained based on a training limit associated with training output. In some instances, the machine-learned sequence processing model can be trained to generate output by identifying a number of times that output of the same type was previously generated. The number of times that the occurrence(s) of output were previously generated can be identified and compared to a limit by identifying the corresponding limit (e.g., a service type-oriented limit for training purposes) with content of a same type (e.g., service type-oriented content for training purposes). In those or other examples, the machine-learned sequence processing model can be trained to limit, summarize, prevent, simplify, decrease in size, etc., or any combination thereof, training output based on the number of times being greater than a threshold number.

Training output can be utilized to train the machine-learned sequence processing model to identify output that has a relatively lower level of quality, and/or that is relatively less accurate, less complete, etc., or any combination thereof, than one or more other occurrences of output. For instance, the machine-learned sequence processing model can be trained to manage (e.g., limit, summarize, prevent, simplify, decrease in size, etc., or any combination thereof) such output. In such an instance or another instance, the training output can be utilized to train the machine-learned sequence processing model to manage output based on a parameter of a characteristic (e.g., a size, a complexity, a level of quality, etc., or any combination thereof) of the output. In such an instance or another instance, the machine-learned sequence processing model can be trained to manage output based on the parameter being less than one or more parameters of one or more previous occurrences of output. Such output may include unnecessary or redundant content.

Alternatively or additionally, training output can be utilized to train the machine-learned sequence processing model to one or more occurrences of output that have a relatively greater level of quality, and/or that are relatively more accurate, more complete, etc., or any combination thereof, than one or more other occurrences of output. Output by the trained machine-learned sequence processing model may include valuable and/or helpful content. The training output can be utilized to train the machine-learned sequence processing model based on other training output having a relatively lower level of quality, and/or being relatively less accurate, less complete, etc., or any combination thereof. Training output can be utilized to train the machine-learned sequence processing model to manage output based on a parameter of a characteristic (e.g., a size, a complexity, a level of quality, etc., or any combination thereof) of the output. The machine-learned sequence processing model can be trained to provide output based on the parameter being above one or more parameters of one or more previous occurrences of output.

Training input with relatively smaller, and/or simpler content than in other training input can be utilized to train the machine-learned sequence processing model. One or more training limits associated with training input having such content can be utilized to train the machine-learned sequence processing model to manage (e.g., limit, summarize, prevent, simplify, decrease in size, etc., or any combination thereof) output. For example, the training limit(s) associated with training input can be utilized by the trained machine-learned sequence processing model to manage showcasing for input. The showcasing can be relatively smaller and/or simpler. Alternatively or additionally, the training limit(s) can be utilized to train the machine-learned sequence processing model to prevent unnecessary showcasing for relatively smaller and/or simpler input.

Repetitive occurrences of training input can be utilized to manage (e.g., limit, summarize, prevent, simplify, decrease in size, etc., or any combination thereof) training output. In some examples, one or more training limits can be utilized to train the machine-learned sequence processing model to prevent over saturation of showcasing for repetitive input. For instance, input occurring multiple times may not need to be followed by output, in contrast to new and/or unique input. In such an instance or another instance, input occurring multiple times can be followed by relatively simpler, succinct, concise, etc., output, in comparison to input that is new and/or unique.

With respect to input occurring relatively more frequently and/or occurring a greater number of times than other input, one or more training limits can be utilized to train the machine-learned sequence processing model. For example, the training limit(s) can be utilized to train the machine-learned sequence processing model to generate showcasing that is relatively simpler, succinct, concise, etc., for example occurring relatively more frequently than a frequency threshold. The relatively simpler, succinct, and/or concise showcasing can be utilized for repetitive input so that redundant and/or duplicative output is not generated unnecessarily. In some instances, the training limit(s) can be utilized to train the machine-learned sequence processing model to generate showcasing that is relatively simpler, succinct, concise, etc., for examples occurring a greater number of times (e.g., a greater number of total times, a greater number of times in a period of time, etc.) than a number of occurrences threshold (e.g., a number of total occurrences threshold, a number of times in a period of time threshold, etc.).

Training input that has relatively more complex and/or lengthy content can be utilized to train the machine-learned sequence processing model to manage (e.g., identify, determine, generate, modify, update, fine-tune, analyze, store, delete, transmit, output, etc.) output. Relatively more complex and/or larger sizes of training output can be utilized to train the machine-learned sequence processing model to respond more thoroughly and/or completely to input that has relatively more complex and/or lengthy content. For example, the training output can be utilized to train the machine-learned sequence processing model to provide relatively more complex content output. Such output may include valuable and/or helpful content.

One or more lists (or “pre-determined external service list(s),” or “training list(s)”) can be utilized to train the machine-learned sequence processing model. Alternatively or additionally, one or more training external services can be utilized to train the machine-learned sequence processing model. The computing system can manage (e.g., identify, determine, generate, modify, update, fine-tune, analyze, store, delete, transmit, output, etc.) one or more pre-determined external services (or “training pre-determined external service(s)”) and/or the training list(s) for training purposes. The training list(s) can individually list, itemize, and/or include a set (e.g., a partial set and/or an entire set) of the training pre-determined external service(s). Alternatively or additionally, any of the training list(s) can include individual training identifiers. Alternatively or additionally, any of the training list(s) can have a corresponding set of training data associated with corresponding pre-determined external service(s). In some cases, individual sets of training data can include one or more identifiers, one or more characteristics, and/or one or more specifications associated with corresponding pre-determined external service(s).

The computing system(s) can manage the training pre-determined external service list(s) in various ways. The computing system(s) can automatically construct one or more training examples from one or more initial example outputs. For instance, automatically constructing the training example(s) can include detecting, by the computing system, that an initial example output mentions one of the pre-determined external service(s). In such an instance or another instance, automatically constructing the training example(s) can include, in response to the detecting, adding, by the computing system, additional content to the initial example output that references individual ones of the capability(ies) of the machine-learned sequence processing model relative to the one of the pre-determined external services.

A training example can include a training input and a ground truth training output. The ground truth training output can reference the capability(ies) of the machine-learned sequence processing model. Training the machine-learned sequence processing model using the training example can include performing supervised learning on the training example.

Training the machine-learned sequence processing model can include training at least one training model (e.g., a reward model), such as at least one of the training machine-learned model(s), to generate a positive reward value for model outputs that reference the one or more capabilities of the machine-learned sequence processing model. Training the machine-learned sequence processing model can include performing reinforcement learning on the machine-learned sequence processing model using the reward model. Training the reward model can include training the reward model on human feedback data that indicates a preference for model outputs that reference the one or more capabilities of the machine-learned sequence processing model.

With reference to the category 1, the machine-learned sequence processing model being trained (e.g., being partially trained or fully trained) as a trained machine-learned sequence processing model can be provided as an output (e.g., by the computing system). In some examples, various operations associated with the category 1 202 can be included in the operations 200, based on input to the trained machine-learned sequence processing model. The operations associated with the category 1 202 can be performed based on training of the machine-learned sequence processing model(s). The operations 200 associated with the category 1 202 performed based on training of the machine-learned sequence processing model(s) can include one or more operations that can be performed based on completion of a section (e.g., a partial section or an entire section) of training of the machine-learned sequence processing model(s).

The operations associated with the category 1 202 that can be performed based on training of the machine-learned sequence processing model(s) can, in some cases, be performed further based on one or more triggers (or “external service trigger(s)”) for one or more model tasks 210. The operations associated with the category 1 202 that can be performed based on the external service trigger(s) 210 can include individual ones of one or more operations that are similar to, and/or based on, any of the training operation(s), as discussed above.

Individual ones of the external service trigger(s) may be similar to, and/or based on, any of the training external service trigger(s), as discussed above. The operations (e.g., utilizing the trigger(s) 210) that can be similar to, and/or based on, any of the training operation(s) may be performed based on the machine-learned sequence processing model(s) being trained as one or more trained machine-learned sequence processing models.

Various operations (e.g., and/or various aspects and/or functions related thereto) of the machine-learned sequence processing model(s) (e.g., based on the training) can be performed based on various types of input. For example, the operations of the trained machine-learned sequence processing model(s) can be performed, for instance, based on input, such as user input. In some examples, the aspects and/or functions for operation of the trained machine-learned sequence processing model(s) (e.g., based on the training), similarly to the training aspects and/or training functions, can include obtaining and/or generating model output. Obtaining and/or generating model output can be performed based on one or more pre-determined external service lists, in similar ways as for managing the training model output, as discussed above.

In some examples, the computing system can generate and provide various types of output based on the service type(s). The computing system can manage one or more services (e.g., one or more machine-learned model services) instead of one or more other services (e.g., one or more external services) in input. For instance, the other service(s) may include one or more user-identified services, such as a service identified in, specified by, obtained from, etc., input received from a user.

The computing system can utilize the trained machine-learned sequence processing model to provide various types of output associated with the machine-learned model service(s). Output associated with the machine-learned model service(s) may be utilized to identify, and/or to provide, the machine-learned model service(s). The computing system can output the service(s) (e.g., machine-learned model service(s)), perform one or more operations of the service(s), output one or more identifiers thereof, identify data and/or information associated therewith, and/or output the data and/or the information, or any combination thereof. In some cases, output based on a machine-learned model service can be provided based on a trigger 210 enabling, and possibly requiring, the machine-learned model service to be identified and utilized to provide output.

According to a hypothetical example, a user can ask (e.g., provide a query as input thereto) a model (e.g., an LLM) for an external service (e.g., for category 1), even though the user can just use the model itself. A query could include “what's a good application for translating documents?” A query could include “can you suggest an application that can detect what music is playing [with a song playing]?” In either query, the user could potentially just have directly used the model, instead of requesting which application to use.

In the hypothetical example, the model can be trained based on a mapping of services that is maintained and utilized by the model to recommend tasks that the model can handle. The mapping may be created similarly to how a task list of the model is created (e.g., for category 2). The mapping may be created by analyzing data and/or by prompting the model (e.g., to create the data and/or the mapping). Training examples can be created to teach the model to mention its own capabilities whenever the model mentions any outside service that is included in the mapping. The training examples can be created naturally as part of post-training (e.g., by teaching a training model, such as a reward model, to encourage the mentions of the model's own capabilities). Alternatively or additionally, reinforcement learning with human feedback (RLHF) can be utilized to ensure that the model only mentions its abilities when users would actually find this useful.

Various input (or “user input”) of various types may be identified by the machine-learned sequence processing model(s). Input (e.g., input according to the category 1 202) can include one or more prompts, one or more requests, one or more inquiries, one or more queries. Input can include natural language input or one or more of various types, such as one or more utterances received (e.g., verbally) from the user(s).

Managing the category 1 202, and/or the operation(s) associated therewith, can be performed utilizing, and/or based on, one or more sub-optimal annoyance limits (also simply referred to herein as “limit(s)”) 212. The limit(s) 212 can be utilized in similar ways as for any of the training limit(s), as discussed above, except based on input (e.g., user input) to the trained machine-learned sequence processing model. The limit(s) 212 can be utilized to generate and/or provide model output in similar ways as for any training limit(s) utilized to generate training model output, as discussed above.

With reference to the category 2, various types of operations in the operations 200 can be performed utilizing one or more machine-learned models. The operations 200 can include various training operations and various operations of other types.

One or more training operations (or “training operation(s)”) associated with the category 2 204 can be utilized for training based on one or more task complexities 214. The training based on one or more task complexities 214 can be performed based on training input (e.g., the training example(s), as discussed below in further detail). For example, the training based on task complexity(ies) 214 can include training one or more machine-learned sequence processing models (e.g., the machine-learned sequence processing model(s), as discussed above with reference to FIG. 1) according to the category 2.

Various operations associated with various training tasks of various levels, with which the category 2 can be associated, can be identified and utilized to train, for instance, any of the machine-learned sequence processing model(s). In various examples, any training according to category 2 can be performed similarly to any training according to category 1, as discussed above, except by utilizing one or more training task complexities instead of the training service type(s). For instance, the training operation(s) according to category 2 can be performed similarly to the training operation(s) according to category 1. In such an instance or another instance, any of the training operation(s) according to category 2 can be similar to any of the training operation(s) according to category 1, except by utilizing training task complexity(ies) (e.g., utilized for training based on task complexity(ies) 214) instead of training service type(s) (e.g., utilized for training based on service type(s) 208).

The computing system can utilize various types of training hierarchical-based data for training according to category 2. For example, the system can store one or more training hierarchical representations. Individual ones of the training hierarchical representations can be associated with a plurality of different tasks (or “training task(s)”). For instance, the system can manage (e.g., identify, determine, generate, modify, update, fine-tune, analyze, store, delete, transmit, output, etc.) a training hierarchical representation of the different training tasks.

The training hierarchical representation(s) can be utilized for training to generate example output in various ways. The system can automatically construct one or more training examples. For instance, a training example can be automatically constructed from an initial example output. Automatically constructing the training example can include detecting that the initial example output mentions one of the plurality of different tasks. Alternatively or additionally, automatically constructing the training example can include, in response to the detecting, adding additional content to the initial example output that references one or more capabilities (or “one or more training capability(ies)”) of the machine-learned sequence processing model relative to a different task (or “different training task”) that is hierarchically related to the one of the tasks mentioned in the initial example output.

The additional content (or “additional training content”) can include content (or “training content”) that references one or more training capabilities relative to the different training task of a different training level than a training requested task. One or more different training levels that include the different training level can include one or more training higher levels that are associated with one or more characteristics (or “relatively higher-level characteristic(s)”) of levels that have relatively higher values, such as relatively greater complexity, relatively greater functionality, relatively greater accuracy, relatively greater usability, relatively greater applicability, etc., or any combination thereof.

The additional training content can include content that references the training capability(ies) relative to the different training task of a relatively higher level than a requested training task. One or more different training tasks that include the different training task can be of one or more relatively higher levels. For example, the different training task(s) (e.g., with the relatively higher-level characteristic(s)) can be of relatively higher levels than one or more other training tasks previously identified to be performed, one or more other training tasks currently identified to be performed, and/or one or more other training tasks identified to be potentially performed in the future. In such an example or another example, the different training task(s) can be associated with one or more higher levels that have values that are above a level threshold.

According to a hypothetical example, the training task(s) can be utilized to train a model to output a high-level task (e.g., a relatively higher-level task) identified for a low-level task (e.g., a relatively lower-level task), such as finding grammar mistakes. The low-level task can be associated with a query received from a user. A low-level task may be associated with a query of “can you find grammar mistakes in the beginning of my letter?” The high-level task can include the model writing the whole letter for the user (e.g., and/or the remainder of the letter). Or, a low-level task may be associated with a query received of “What does the third word of the following sentence mean? [sentence]?” The high-level task can include the model just translating entire sentences or documents for the user.

In the hypothetical example, the model can be trained based on a graph of task complexity. For the graph of task complexity, nodes of the graph can include the tasks from a task list (e.g., a hierarchical list and/or representation, initially created for training the model). For the graph of task complexity, a node X can be a child of node Y if task X could be done as part of performing task Y. Task X (e.g., the task of fixing grammar error mistakes) could be done as part of the task Y (e.g., the task of writing the letter). then create training examples that teach the model that whenever it solves a task, it can additionally suggest parent tasks from this graph. Such training can be done as part of post-training, and/or in combination with RLHF.

Training the machine-learned sequence processing model according to the category 2 204, and/or managing the training operation(s) associated therewith, can be performed utilizing, and/or based on, one or more training sub-optimal annoyance limits (also simply referred to herein as “training limit(s)”). The training limit(s) can be utilized in similar ways as for any of the training limit(s) associated with the category 1 202, as discussed above, except based on training input associated with the low-level task(s). The training limit(s) can be utilized to generate and/or provide model output in similar ways as for any training limit(s) utilized to generate training model output based on training input associated with external service(s), as discussed above.

With reference to the category 2, the machine-learned sequence processing model being trained as a trained machine-learned sequence processing model can be provided as an output (e.g., by the computing system). In some examples, various operations associated with the category 2 204 being performed based on input can be included in the operations 200. The operations associated with the category 2 204 can be performed based on training of the machine-learned sequence processing model(s). The operations 200 associated with the category 2 204 performed based on training of the machine-learned sequence processing model(s) can include one or more operations that can be performed based on completion of a section (e.g., a partial section or an entire section) of training of the machine-learned sequence processing model(s).

The operations associated with the category 2 204 that can be performed based on training of the machine-learned sequence processing model(s) can, in some cases, be performed further based on one or more triggers (or “hierarchical trigger(s)”) for one or more low-level tasks 216. For example, one or more operations associated with the hierarchical trigger(s) can be associated with one or more tasks identified based on input (e.g., user input). In such an example or another example, the operation(s)/task(s) identified based on input can include one or more tasks of relatively lower levels than one or more other tasks previously performed, one or more other tasks currently being performed, and/or one or more other tasks potentially to be performed in the future. In such an example or another example, the operation(s)/task(s) identified based on input can be associated with one or more lower levels that have values that are less than a level threshold.

Any of the operation(s) associated with the hierarchical trigger(s) 216 can be similar to, and/or based on, the operation(s) (e.g., the training operation(s)) utilized for the training based on task complexity(ies) 214. For instance, the operation(s) associated with the hierarchical trigger(s) can be utilized to manage hierarchical representation(s) similarly to, and/or based on, the training 214 (e.g., the training operation(s) utilized to manage the training hierarchical representation), as discussed above. The operation(s) associated with the hierarchical trigger(s) 216 can be similar to, and/or based on, the training operation(s) associated with the training hierarchical trigger(s), except with the operation(s) associated with the hierarchical trigger(s) 216 being performed based on input (e.g., user input).

In some examples, the computing system can generate and provide various types of output based on the hierarchical representation. The computing system can manage one or more tasks of relatively higher levels than one or more tasks identified in input. The computing system can output the task(s), one or more identifiers thereof, and/or data and/or information associated therewith, or any combination thereof.

In alternative or additional examples, the computing system can generate and provide various types of output according to the category 2 204 in response to input. Input according to the category 2 204 can include input (or “user input”), such as one or more occurrences of input received from one or more users. Input according to the category 2 204 can include one or more prompts, one or more requests, one or more inquiries, one or more queries. For example, input according to the category 2 204 can include natural language input or one or more of various types, such as one or more utterances received (e.g., verbally) from the user(s). The output based on the hierarchical representation can be provided based on a hierarchical trigger 216 enabling, and possibly requiring, the hierarchical representation to be utilized to provide output.

Managing the category 2 204, and/or the operation(s) associated therewith, can be performed utilizing, and/or based on, one or more sub-optimal annoyance limits (also simply referred to herein as “limit(s)”) 218. The limit(s) 218 can be utilized in similar ways as for any of the limit(s) 212, as discussed above, except based on input associated with the low-level task(s). The limit(s) 218 can be utilized to generate and/or provide model output in similar ways as for any limit(s) 212, except with model output associated with the category 2204 instead of the category 1 202.

With reference to the category 3, various types of operations (e.g., various training operations and various operations of other types) in the operations 200 can be performed utilizing one or more machine-learned models. One or more training operations (or “training operation(s)”) associated with the category 3 206 can be utilized for training based on one or more supplemental features (e.g., one or more preferred input data features) 220. The training based on one or more task complexities 214 can be performed based on training input (e.g., the training example(s), as discussed below in further detail). For example, the training based on supplemental feature(s) 220 can include training one or more machine-learned sequence processing models (e.g., the machine-learned sequence processing model(s), as discussed above with reference to FIG. 1) according to the category 3.

Various operations associated with supplemental features of various types, with which the category 3 can be associated, can be identified and utilized to train, for instance, any of the machine-learned sequence processing model(s). In various examples, any training according to category 3 can be performed similarly to any training according to category 1, as discussed above, except by utilizing one or more training supplemental features instead of the training service type(s). For instance, the training operation(s) according to category 3 can be performed similarly to the training operation(s) according to category 1. In such an instance or another instance, any of the training operation(s) according to category 3 can be similar to any of the training operation(s) according to category 1, except by utilizing the supplemental feature(s) (e.g., utilized for training based on supplemental feature(s) 220) instead of training service type(s) (e.g., utilized for training based on service type(s) 208).

The system can utilize various types of training missing feature-based data for training according to category 3. For example, the system can store one or more training missing features. Individual ones of the training missing feature(s) can include, and/or be associated with, one or more words, one or more depictions, one or more operations, one or more services, one or more functions, etc., or any combination thereof). Individual ones of the training missing feature(s) can be associated with a training example (e.g., any of the training example(s), as discussed below in further detail).

In some instances, the system can manage (e.g., identify, determine, generate, modify, update, fine-tune, analyze, store, delete, transmit, output, etc.) one or more training sets of one or more training supplemental features. For example, the system can store, for one or more tasks, a training set of one or more training supplemental features, such as one or more preferred input data features (e.g., or a training dataset of one or more training few-shot examples having one or more training preferred input data features).

The training supplemental feature(s), such as one or more training sets that individually have one or more training supplemental features, can be utilized for training any of the machine-learned sequence processing model(s) to generate example output in various ways. The system can automatically construct one or more training examples. For instance, a training example can be automatically constructed from an initial example output. Automatically constructing the training example can include detecting that the initial example output mentions one or more tasks (e.g., for which corresponding preferred supplemental feature(s) are stored). Alternatively or additionally, automatically constructing the training example can include, in response to the detecting, adding additional content to the initial example output that references one or more capabilities (or “training capability(ies)”) of the machine-learned sequence processing model relative to the supplemental features(s) (e.g., the preferred input data feature(s)).

The additional content (or “additional training content”) can include content (or “training content”) that references the training capability(ies) relative to the training supplemental feature(s). One or more different training supplemental features that are potentially utilizable to satisfy one or more training indicators of the training missing feature(s) can be utilized to train the machine-learned sequence processing model. For example, individual ones of the training indicator(s) can identify, and/or include data and/or information associated with, a training missing feature. The training supplemental feature(s) and/or the training missing feature(s) can be utilized to train the machine-learned sequence processing model. The training supplemental feature(s) and/or the training missing feature(s) can be utilized for training purposes based on the training capability(ies) (e.g., of the machine-learned sequence processing model relative to the supplemental features(s)) being referenced in the additional content added to the initial example output.

Training the machine-learned sequence processing model according to the category 3 206, and/or managing the training operation(s) associated therewith, can be performed utilizing, and/or based on, one or more training sub-optimal annoyance limits (also simply referred to herein as “training limit(s)”). The training limit(s) can be utilized in similar ways as for any of the training limit(s) associated with the category 1 202, as discussed above, except based on training input associated with the missing feature(s). The training limit(s) can be utilized to generate and/or provide model output in similar ways as for any training limit(s) utilized to generate training model output based on training input associated with the missing feature(s), as discussed above.

With reference to the category 3, the machine-learned sequence processing model being trained as a trained machine-learned sequence processing model can be provided as an output (e.g., by the computing system). In some examples, various operations associated with the category 3 206 being performed based on input can be included in the operations 200. The operations associated with the category 3 206 can be performed based on training of the machine-learned sequence processing model(s). The operations 200 associated with the category 3 206 performed based on training of the machine-learned sequence processing model(s) can include one or more operations that can be performed based on completion of a section (e.g., a partial section, or an entire section with all) of training of the machine-learned sequence processing model(s).

According to a hypothetical example, a query to a model (e.g., an LLM) may be replaceable by a more effective query with different features. The query may be relatively less effective if it has missing features. A query could include “what does the traffic sign with [detailed description of the sign] mean?” However, a simpler and/or more effective query could include a photo of the sign. A query could include “I'm listening to a song that goes [detailed song lyrics] . . . what's the song's name?” However, a simpler and/or more effective query could include an audio message, such as a message recorded by a device of a user.

In the hypothetical example, the model can be trained (e.g., such as for the category 3) to include, for each task in the task list, a dataset of few-shot examples. The model can be trained to inform the user, whenever some few-shot features are missing (e.g., a photo of something and/or an audio file), that the model could do a better job (e.g., provide a more accurate output, respond more quickly/efficiently, etc.) if the missing features were also provided. The model could be trained in such a way, as part of post-training and/or in combination with RLHF.

The operations associated with the category 3 206 that can be performed based on training of the machine-learned sequence processing model(s) can, in some cases, be performed further based on one or more triggers (or “missing feature trigger(s)”) for one or more initial tasks (e.g., one or more portions of tasks, possibly including one or more partial/not-fully-complete tasks) 222. For example, one or more operations associated with the missing feature trigger(s) can be associated with one or more tasks identified based on input. The operations 200 associated with the category 3 206 performed based on input to the machine-learned sequence processing model(s), in a similar way as for the training operations associated with the category 3 206 performed based on training input to the machine-learned sequence processing model(s).

In some examples, the computing system can generate and provide various types of output according to the category 3 206 in response to input. Input according to the category 3 206 can include input (or “user input”), such as one or more occurrences of input received from one or more users. Input according to the category 3 206 can include one or more prompts, one or more requests, one or more inquiries, one or more instructions, one or more queries, one or more commands, one or more communications, etc., or any combination thereof. For example, input according to the category 3 206 can include natural language input or one or more of various types, such as one or more utterances received (e.g., verbally) from the user(s). Output based on a supplemental feature can be provided based on a trigger 222 enabling, and possibly requiring, the supplemental feature to be identified and utilized to provide output.

Managing the category 3 206, and/or the operation(s) associated therewith, can be performed utilizing, and/or based on, one or more sub-optimal annoyance limits (also simply referred to herein as “limit(s)”) 224. The limit(s) 224 can be utilized in similar ways as for any of the limit(s) 212, as discussed above, except based on input associated with the missing feature(s). The limit(s) 224 can be utilized to generate and/or provide model output in similar ways as for any limit(s) 224, except with model output associated with the category 3 206 instead of the category 1 202.

While the system can manage individual sets of training supplemental feature(s), as discussed above in the current disclosure, it is not limited as such. In some examples, the system can, in a similar or same way, manage individual ones of one or more datasets of few-shot examples having training supplemental features (e.g., preferred input data features). In those or other examples, the system can manage the corresponding dataset(s) associated with different input (e.g., different training example(s)). In those or other examples, the system can manage individual ones of the dataset(s) of few-shot examples having training supplemental features in a similar way as for corresponding sets of the set(s) of training supplemental feature(s) for purposes of performing any of the techniques discussed herein.

While the training operation(s) associated with the category(ies) 1-3 202-206 can include training the machine-learned sequence processing model(s) (e.g., the machine-learned sequence processing model(s), as discussed above in the current disclosure, it is not limited as such. In some examples, any of the machine-learned sequence processing model(s) being trained via any of the training operation(s) associated with the category(ies) 1-3 202-206 can be combined (e.g., integrated with) together and/or separate from one another. In those or other examples, any of the training operation(s) associated with the category(ies) 1-3 202-206 can be utilized to train at least one of any of the machine-learned sequence processing model(s) being trained via any of the training operation(s) associated with the category(ies) 1-3 202-206.

Various operations can be utilized for operation(s) and/or training operation(s) of the machine-learned sequence processing model(s). Utilizing the machine-learned sequence processing model(s) for showcasing can include processing, by the computing system, an input with the machine-learned sequence processing model(s) to generate an additional output that references one or more capabilities of the machine-learned sequence processing model(s). Training the machine-learned sequence processing model(s) for showcasing can include observing, by the computing system, one or more user interactions with the generated additional output. The interaction(s) and/or additional output can be utilized to train the machine-learned sequence processing model(s).

Training the machine-learned sequence processing model(s) can include identifying user-specific data associated with a plurality of users, and training, by the computing system using the training example, the machine-learned sequence processing model(s) to generate the model output that references the one or more capabilities of the machine-learned sequence processing model(s) corresponding to individual ones of the plurality of users.

A user may be provided with controls allowing the user to make an election as to both if and how systems, programs, or features described herein may utilize their interaction data for personalizing the showcasing of model capabilities. Such interaction data may include, for example, the user's history of queries to the model, tasks requested, responses to previously showcased capabilities, or an inferred level of the user's familiarity or expertise with the model's features. Controls may also govern if the user is presented with such personalized showcases of model capabilities that are based on this interaction data.

In addition, certain interaction data may be treated in one or more ways before it is stored or used, so that personally identifiable information (PII) is removed or obscured. For example, a user's specific identity may be treated (e.g., through pseudonymization or by analyzing data in an aggregated, de-identified form) so that PII cannot readily be determined for the user in such contexts. If any contextual information like generalized location (e.g., to a city or region) is used to tailor showcasing of location-relevant capabilities, it may be generalized so that a specific location of a user cannot be determined. Thus, the user may have control over how their interaction history is utilized to personalize the showcasing experience and what personalized content related to model capabilities is provided to them.

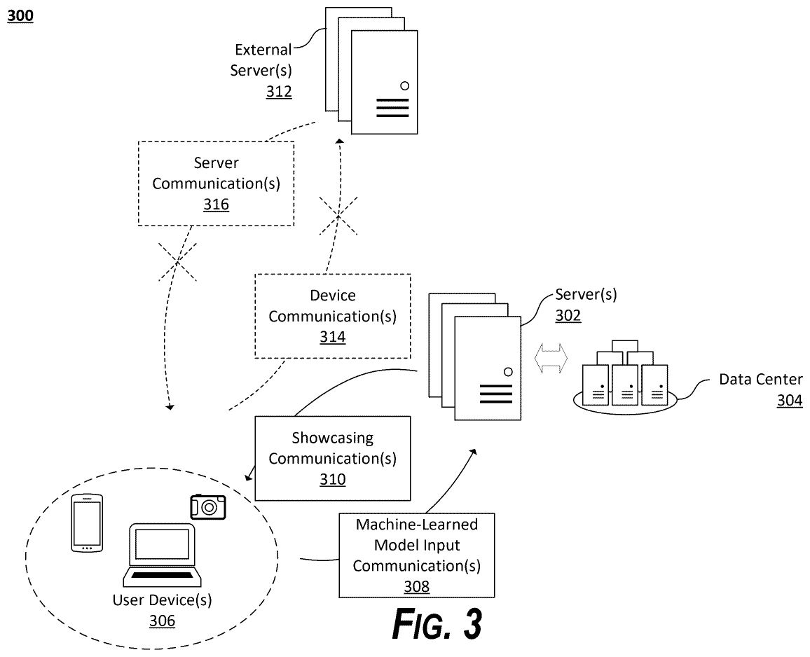

FIG. 3 depicts an environment including one or more systems 300 for performance of training showcasing operations and showcasing operations, according to example embodiments of the present disclosure. The system(s) 300 can include one or more servers 302, which can be utilized to implement one or more computing systems (e.g., the computing system utilized to perform the operations 100 and/or 200, as discussed above with reference to FIGS. 1 and 2). The server(s) 302 can be communicatively coupled to a data center 304, which can be utilized, alternatively or additionally to the server(s) 302, to perform the operations 100 and/or 200, as discussed above with reference to FIGS. 1 and 2).

The system(s) 300 can include one or more devices, such as one or more user devices 306 associated with one or more users. The system(s) 300 can be utilized to exchange one or more communications between the server(s) 302 and the device(s) 306.

The communication(s) exchanged via the system(s) 300 can include one or more machine-learned model input communications 308 (also simply referred to herein as “communication(s)”) transmitted by the user device(s) 306. The communication(s) 308 can include one or more communications associated with the machine-learned sequence processing model(s) utilized to perform any of the operations 100 and/or 200, as discussed above with reference to FIGS. 1 and 2. For example, the communication(s) 308 can include one or more natural language communications (e.g., one or more natural language messages). Individual ones of the natural language communication(s) can include a prompt, a request, an inquiry, an instruction, a query, a command, any communication of any other type, and so on, or any combination thereof. In some examples, the communication(s) 308 can be provided as, and/or can include content provided as, input to the machine-learned sequence processing model(s).

The communication(s) exchanged via the system(s) 300 can include one or more showcasing communications (also referred to herein simply as “communication(s)” 310 transmitted by the server(s) 302. The communication(s) 310 can include one or more communications associated with the machine-learned sequence processing model(s) utilized to perform any of the operations 100 and/or 200, as discussed above with reference to FIGS. 1 and 2. For example, the communication(s) 310 can include one or more natural language communications (e.g., one or more natural language messages). Individual ones of the natural language communication(s) can include a prompt, a request, an inquiry, an instruction, a query, a command, a communication, any communication of any other type, and so on, or any combination thereof. In some examples, the communication(s) 310 can be provided as, and/or can include content provided as, output of the machine-learned sequence processing model(s).

Various benefits with respect to the system(s) 300 may occur as a result of the communication(s) 308 and/or 310, alternatively or additionally to, operations performed by the machine-learned sequence processing model(s). For example, the system(s) 300, the user device(s) 306, and/or one or more external servers 312, may not need to perform various operations and/or exchange various communications. The system(s) 300, the user device(s) 306, and/or the external server(s) 312 may not need to perform lengthy, resource intensive, and/or complex operations related to communications identifying external services according to category 1 (e.g., the category 1 202, as discussed above with reference to FIG. 2). Alternatively or additionally, the system(s) 300, the user device(s) 306, and/or the external server(s) 312 may not need to perform unnecessary or inefficient operations related to communications with relatively lower-level tasks according to category 2 (e.g., the category 2 204, as discussed above with reference to FIG. 2). Alternatively or additionally, the system(s) 300, the user device(s) 306, and/or the external server(s) 312 may not need to perform unnecessary or inefficient operations related to communications with missing features according to category 3 (e.g., the category 3 206, as discussed above with reference to FIG. 2).

The system(s) 300 may not need to exchange various communications, such as one or more device communications 314 and/or one or more server communications, between the user device(s) 306 and/or one or more external servers 312. The system(s) 300, the user device(s) 306, and/or the external server(s) 312 may not need to exchange communications (e.g., any corresponding ones of the communication(s) 314 and/or 316) associated with external services associated with category 1. Alternatively or additionally, the system(s) 300, the user device(s) 306, and/or the external server(s) 312 may not need to exchange communications (e.g., any corresponding ones of the communication(s) 314 and/or 316) associated with relatively low-level tasks associated with category 2. Alternatively or additionally, the system(s) 300, the user device(s) 306, and/or the external server(s) 312 may not need to exchange communications (e.g., any corresponding ones of the communication(s) 314 and/or 316) associated with missing features associated with category 3.

While the device(s) can include the device(s) (e.g., the user devices 306) associated with the user(s) as discussed above in the current disclosure, it is not limited as such. In some examples, the device(s) may be associated with any of one or more individuals of any type, such as an operator, an administrator, a client, a customer, and so on, or any combination thereof.

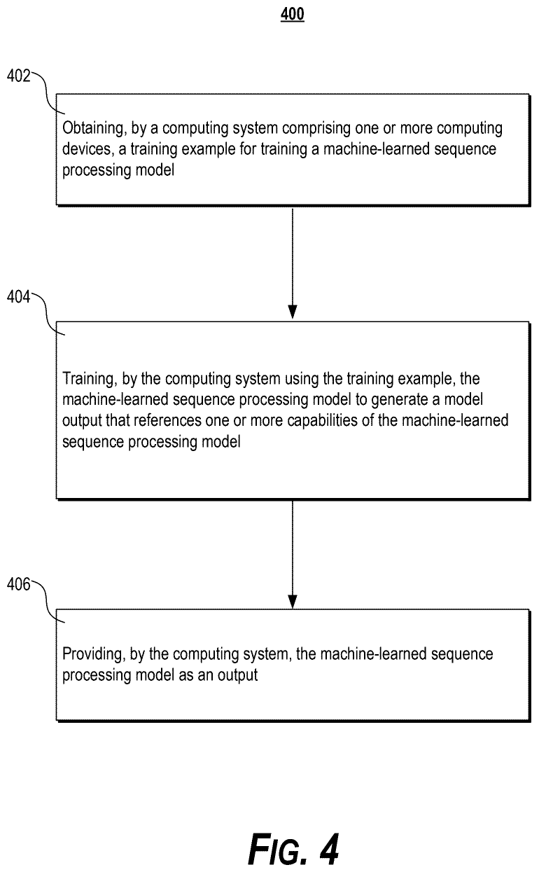

FIG. 4 is a flow chart diagram illustrating an example method 400 for training showcasing operations, according to example implementations of aspects of the present disclosure.

At 402, the method 400 can include obtaining, by a computing system including one or more computing devices, a training example for training a machine-learned sequence processing model. In some examples, the training example can include any of the training examples as discussed above with reference to FIGS. 1-3. For instance, the training example can be utilized in the training showcasing operation(s) 102, including the training category 1 operation(s) 104, the training category 2 operation(s) 106, and/or the training category 3 operation(s) 108. In the instance or another instance, the training example can be utilized for the training based on service type(s) 208, the training based on tax complexity(ies) 214, and/or the training based on supplemental feature(s) 220.

At 404, the method 400 can include training, by the computing system using the training example, the machine-learned sequence processing model to generate a model output that references one or more capabilities of the machine-learned sequence processing model. In some examples, the model output can include any of the model output as discussed above with reference to FIGS. 1-3. For instance, the model output can be utilized in, and/or managed (e.g., identified, determined, generated, modified, updated, deleted, replaced, etc.) via the training showcasing operation(s) 102, including the training category 1 operation(s) 104, the training category 2 operation(s) 106, and/or the training category 3 operation(s) 108.

In such an instance or another instance, the model output can be utilized in the training based on service type(s) 208, the training based on tax complexity(ies) 214, and/or the training based on supplemental feature(s) 220. In such an instance or another instance, the model output can be utilized to train the machine-learned sequence processing model to perform the showcasing operation(s) 110, including the category 1 operation(s) 112, the category 2 operation(s) 114, and/or the category 3 operation(s) 116. In the instance or another instance, the model output can be utilized to manage the external service trigger(s) 210, the hierarchical trigger(s) 216, and/or the missing feature trigger(s) 222.

At 406, the method 400 can include providing, by the computing system, the machine-learned sequence processing model as an output. The machine-learned sequence processing model can be provided as an output and utilized to perform the showcasing operation(s) 110, including the category 1 operation(s) 112, the category 2 operation(s) 114, and/or the category 3 operation(s) 116. In the instance or another instance, the machine-learned sequence processing model being output can be utilized to perform various types of applicable showcasing operations based on the external service trigger(s) 210, the hierarchical trigger(s) 216, and/or the missing feature trigger(s) 222.

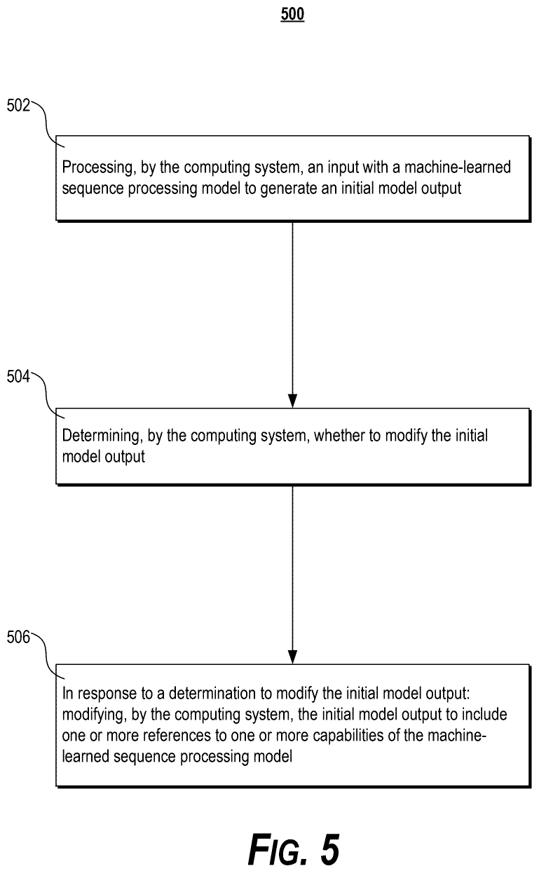

FIG. 5 is a flow chart diagram illustrating an example method 500 for showcasing operations, according to example implementations of aspects of the present disclosure.

At 502, the method 500 can include processing, by the computing system, an input with a machine-learned sequence processing model to generate an initial model output.

In some examples, the initial model output can include any of the model output as discussed above with reference to FIGS. 1-3. For instance, the initial model output can be utilized in, and/or managed (e.g., identified, determined, generated, modified, updated, deleted, replaced, etc.) based on based on training performed via the training showcasing operation(s) 102, including the training category 1 operation(s) 104, the training category 2 operation(s) 106, and/or the training category 3 operation(s) 108.

At 504, the method 500 can include determining, by the computing system, whether to modify the initial model output. The computing system can determine to modify the initial model output based on training performed via the training showcasing operation(s) 102, including the training category 1 operation(s) 104, the training category 2 operation(s) 106, and/or the training category 3 operation(s) 108.

At 506, the method 500 can include, in response to a determination to modify the initial model output, modifying, by the computing system, the initial model output to include one or more references to one or more capabilities of the machine-learned sequence processing model. The initial model output can be modified to include the reference(s) to the capability(ies) of the machine-learned sequence processing model, based on based on training performed via the training showcasing operation(s) 102, including the training category 1 operation(s) 104, the training category 2 operation(s) 106, and/or the training category 3 operation(s) 108. In various examples, the initial model output can be utilized to perform, by the machine-learned sequence processing model, one or more operations, such as the category 1 operation(s) 112, the category 2 operation(s) 114, and/or the category 3 operation(s) 116. The initial model output can be modified to be model output, which can include the reference(s) to the capability(ies) of the machine-learned sequence processing model.

The initial model output can be modified based on the computing system detecting that the initial model output mentions one of a number of pre-determined external services. The determining whether to modify the initial model output can be performed based on training, using a training example, the machine-learned sequence processing model to generate the initial model output that references the capability(ies) of the machine-learned sequence processing model corresponding to individual ones of the plurality of users. The determining whether to modify the initial model output can include detecting that the initial model output mentions one of the number of pre-determined external services.

The determining whether to modify the initial model output can be utilized for various purposes. The determining whether to modify the initial model output can include, in response to said detecting, adding additional content to the initial model output that references the capability(ies) of the machine-learned sequence processing model relative to the one of the pre-determined external services. Alternatively or additionally, the determining whether to modify the initial model output can include, in response to said detecting, adding additional content to the initial model output that references the capability(ies) of the machine-learned sequence processing model relative to a different task that is hierarchically related to the one of the tasks mentioned in the initial model output. Alternatively or additionally, the determining whether to modify the initial model output can include, in response to said detecting, adding additional content to the initial model output that references the capability(ies) of the machine-learned sequence processing model relative to one or more preferred input data features.

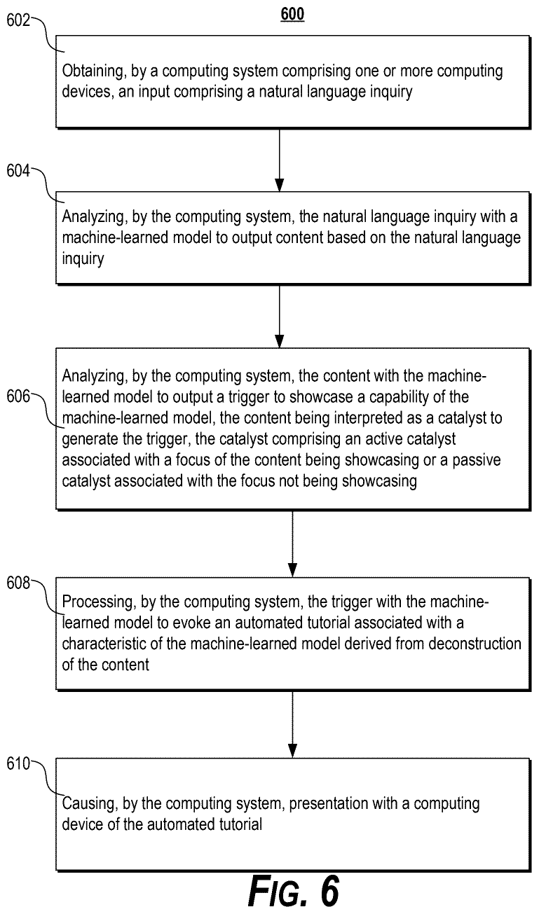

FIG. 6 is a flow chart diagram illustrating an example method 600 for showcasing operations, according to example implementations of aspects of the present disclosure.

At 602, the method 600 can include obtaining, by a computing system including one or more computing devices, an input including a natural language inquiry. The natural language inquiry can be input to any of the machine-learned sequence processing models as discussed above with reference to FIGS. 1-3. The natural language inquiry can be input to perform the showcasing operation(s) 110, including the category 1 operation(s) 112, the category 2 operation(s) 114, and/or the category 3 operation(s) 116.

At 604, the method 600 can include analyzing, by the computing system, the natural language inquiry with a machine-learned model to output content based on the natural language inquiry. The content can be output based on the natural language inquiry, via the category 1 operation(s) 112, the category 2 operation(s) 114, and/or the category 3 operation(s) 116. In the instance or another instance, the content can be output to perform various types of applicable showcasing operations based on the external service trigger(s) 210, the hierarchical trigger(s) 216, and/or the missing feature trigger(s) 222.

At 606, the method 600 can include analyzing, by the computing system, the content with the machine-learned model to output a trigger to showcase a capability of the machine-learned model, the content being interpreted as a catalyst (e.g., a portion of content in a communication) to generate the trigger, the catalyst including an explicit catalyst associated with a focus of the content being showcasing or an implicit catalyst associated with the focus not being showcasing. The capability being showcased can be triggered via the category 1 operation(s) 112, the category 2 operation(s) 114, and/or the category 3 operation(s) 116. The catalyst can include a prompt, a request, an inquiry, an instruction, a query, a command, any communication of any other type, or any combination thereof.

At 608, the method 600 can include processing, by the computing system, the trigger with the machine-learned model to evoke an automated tutorial associated with a characteristic of the machine-learned model derived from deconstruction of the content. For instance, the trigger being triggered to perform various types of applicable showcasing operations can include at least one of the external service trigger(s) 210, the hierarchical trigger(s) 216, and/or the missing feature trigger(s) 222.

At 610, the method 600 can include causing, by the computing system, presentation with a computing device of the automated tutorial. For example, the automated tutorial presented via the category 1 operation(s) 112, the category 2 operation(s) 114, and/or the category 3 operation(s) 116.

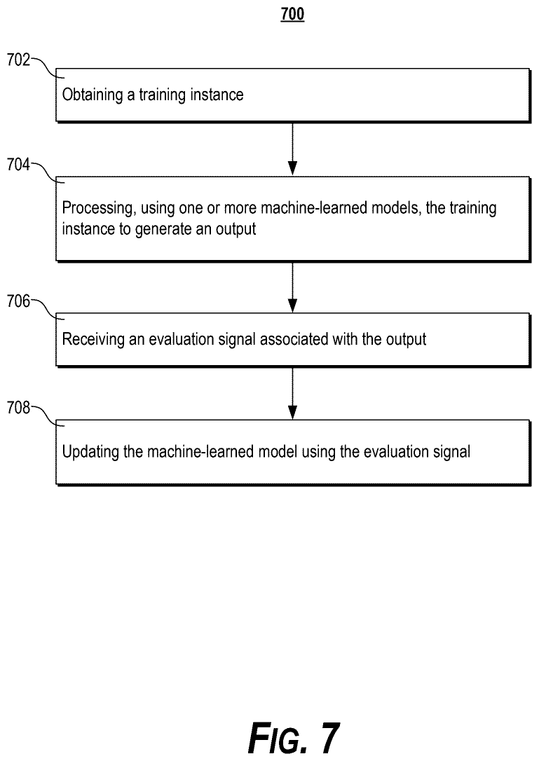

FIG. 7 depicts a flowchart of a method 700 for training one or more machine-learned models according to aspects of the present disclosure. For instance, an example machine-learned model can include individual ones of the training machine-learned model(s), as discussed above with reference to FIGS. 1-3. In such an instance or another instance, the example machine-learned model, and/or another example machine-learned model, can include individual ones of the machine-learned model(s) (e.g., the trained machine-learned model(s)), such as the machine-learned sequence processing model(s), as discussed above with reference to FIGS. 1-3.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types.

In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 700 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 700 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

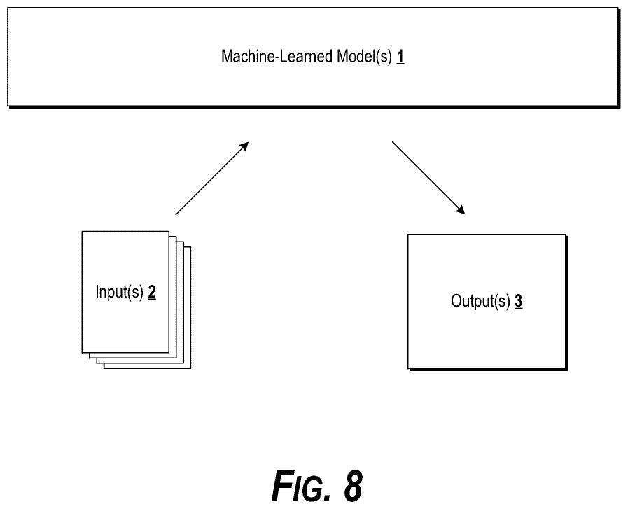

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of the training machine-learned model(s), the trained machine-learned model(s) (e.g., partially and/or fully trained machine-learned model(s)), etc. Although various features, variations, and implementations described below are described with respect to machine-learned model(s) 1, it is to be understood that such features, variations, and implementations are to be understood as described with respect to each of the training machine-learned model(s), the trained machine-learned model(s) (e.g., partially and/or fully trained machine-learned model(s)), and/or any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv: 1242.09368v2 (Oct. 14, 1022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

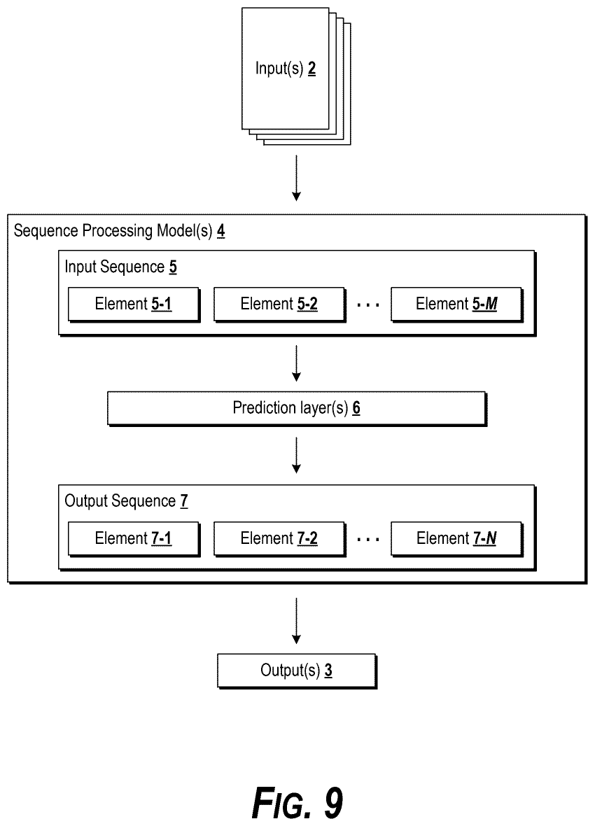

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Sequence processing models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, Google, https: //arxiv. org/abs/2403.08295; Gemma 2: Improving Open Language Models at a Practical Size, Google, https: //arxiv. org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, Google, https://arxiv.org/abs/2407.07726; PaliGemma 2: A Family of Versatile VLMs for Transfer, Google, https://arxiv.org/abs/2412.03555; Flamingo: a Visual Language Model for Few-Shot Learning, Google, https://arxiv.org/abs/1244.14198; PaLI: A Jointly-Scaled Multilingual Language-Image Model, Google, https://arxiv.org/abs/1249.06794.

Sequence processing model(s) 4 can be multimodal. Example multimodal sequence processing models include, for instance, models described in Gemini: A Family of Highly Capable Multimodal Models, Google, https://arxiv.org/abs/2216.11805; Gemini 1.5: Unlocking multimodal understanding across millions of tokens of context, Google, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, arXiv: 2010.11929v2 (Jun. 3, 1021), audio domains, see, e.g., Agostinelli et al., MusicLM: Generating Music From Text, arXiv: 2301.11325v1 (Jan. 26, 1023), biochemical domains, see, e.g., Jumper et al., Highly accurate protein structure prediction with AlphaFold, 596Nature 583 (Aug. 26, 1021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2,. 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 9 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv: 1706.03762v7 (Aug. 2, 1023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv: 1004.07437v3 (Nov. 16, 1020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

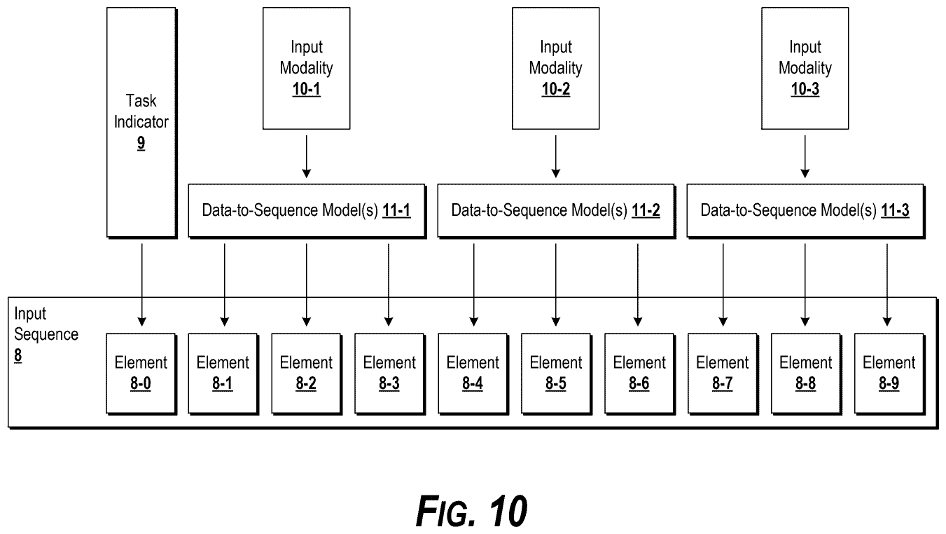

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

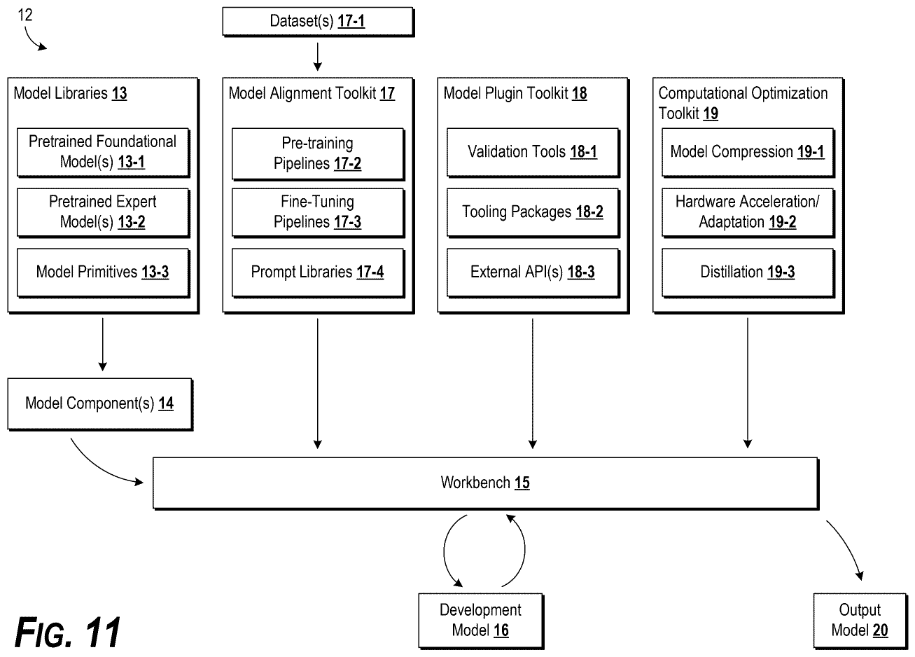

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 900 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

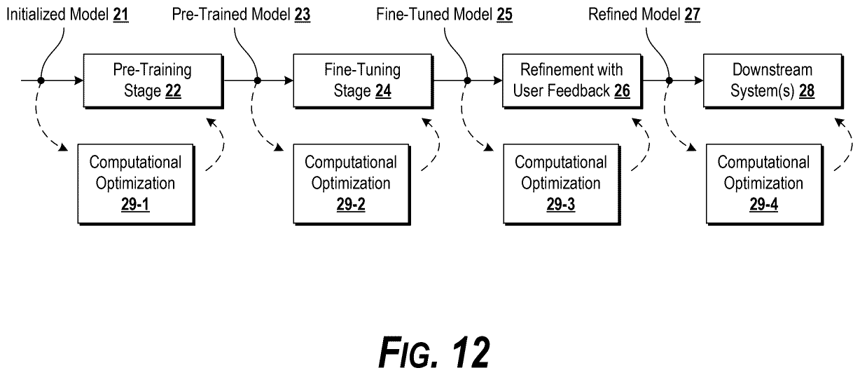

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1,. 29-4 can all be the same, all be different, or include at least some different optimization techniques.

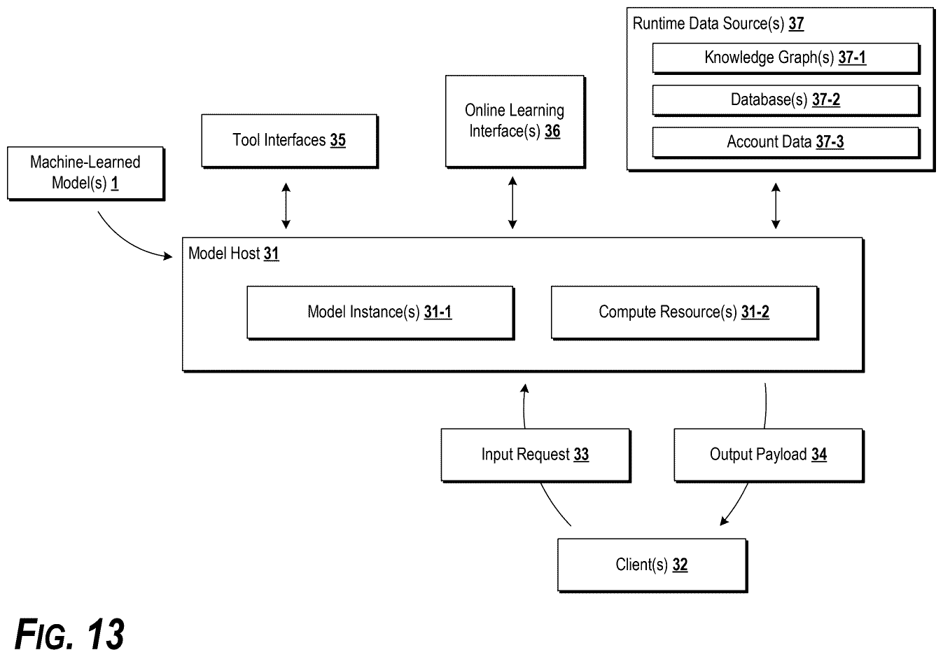

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate RLHF. Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

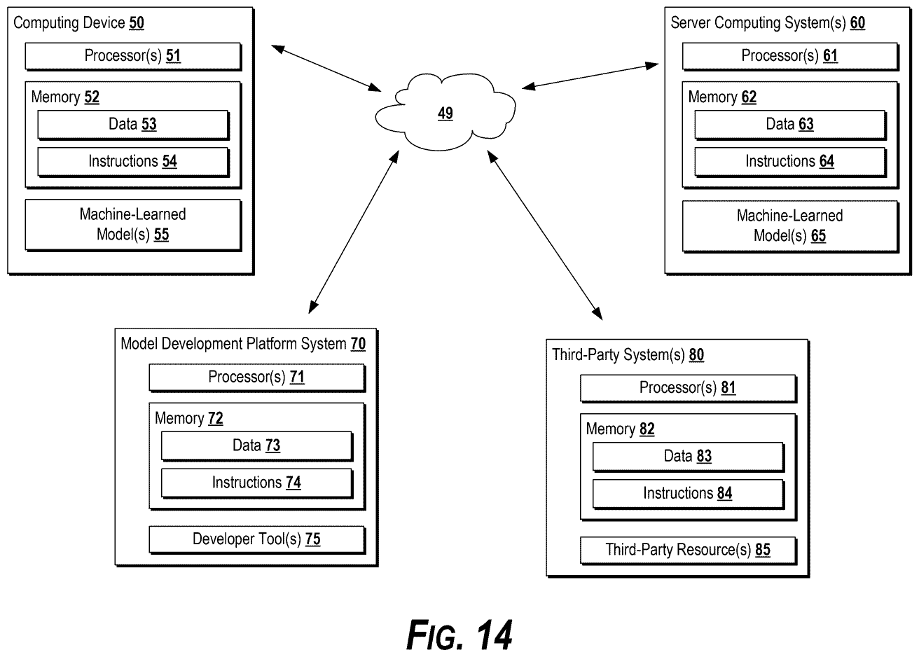

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 14 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

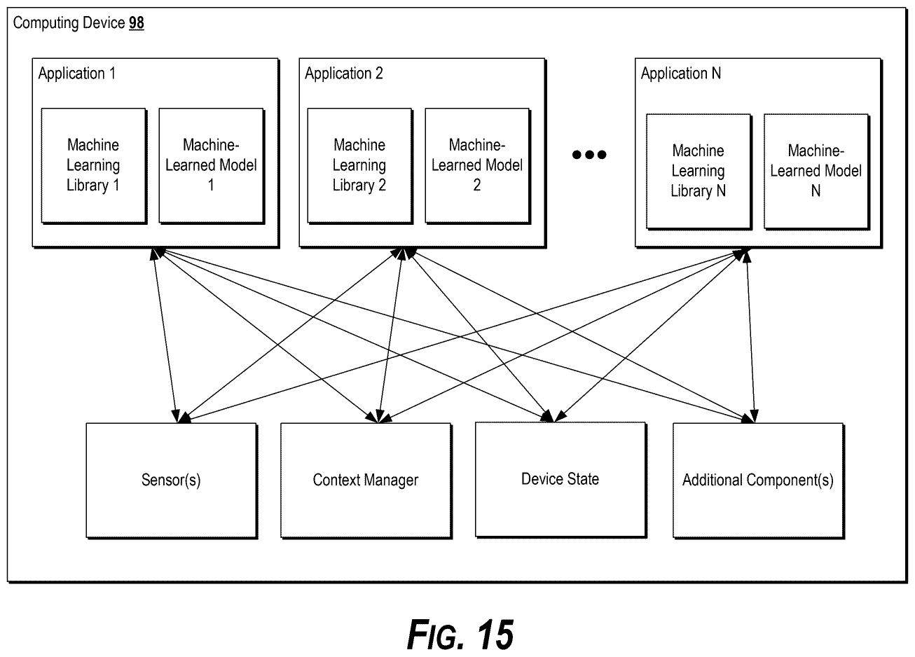

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

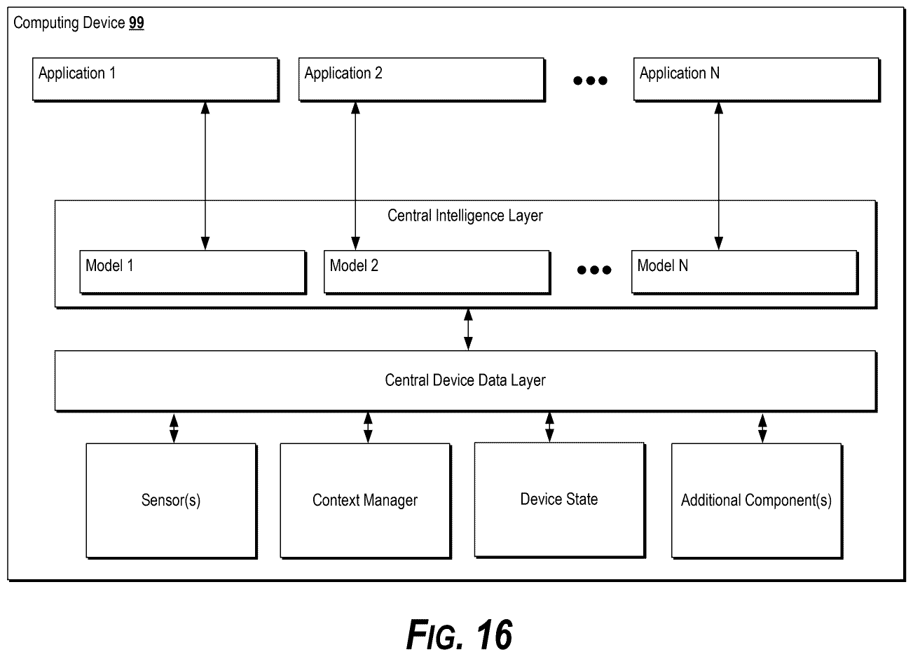

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in 16 18, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
obtaining, by a computing system comprising one or more computing devices, a training example for training a machine-learned sequence processing model;
training, by the computing system using the training example, the machine-learned sequence processing model to generate a model output that references one or more capabilities of the machine-learned sequence processing model; and
providing, by the computing system, the machine-learned sequence processing model as an output.

2. The computer-implemented method of claim 1, further comprising:
storing, by the computing system, a list of pre-determined external services;
automatically constructing, by the computing system, the training example from an initial example output, wherein automatically constructing the training example comprises:
detecting, by the computing system, that the initial example output mentions one of the pre-determined external services; and
in response to said detecting: adding, by the computing system, additional content to the initial example output that references the one or more capabilities of the machine-learned sequence processing model relative to the one of the pre-determined external services.

3. The computer-implemented method of claim 1, further comprising:
storing, by the computing system, a hierarchical representation of a plurality of different tasks; and
automatically constructing, by the computing system, the training example from an initial example output, wherein automatically constructing the training example comprises:
detecting, by the computing system, that the initial example output mentions one of the plurality of different tasks; and
in response to said detecting: adding, by the computing system, additional content to the initial example output that references the one or more capabilities of the machine-learned sequence processing model relative to a different task that is hierarchically related to the one of the tasks mentioned in the initial example output.

4. The computer-implemented method of claim 1, further comprising:
storing, by the computing system and for one or more tasks, one or both of a set of preferred input data features or a dataset of few-shot examples having the preferred input data features;
automatically constructing, by the computing system, the training example from an initial example output, wherein automatically constructing the training example comprises:
detecting, by the computing system, that the initial example output mentions or performs the one or more tasks; and
in response to said detecting: adding, by the computing system, additional content to the initial example output that references the one or more capabilities of the machine-learned sequence processing model relative to the preferred input data features.

5. The computer-implemented method of claim 1, wherein the training example comprises a training input and a ground truth training output, wherein the ground truth training output references the one or more capabilities of the machine-learned sequence processing model, and wherein training, by the computing system using the training example, the machine-learned sequence processing model comprises performing, by the computing system, supervised learning on the training example.

6. The computer-implemented method of claim 1, wherein training, by the computing system using the training example, the machine-learned sequence processing model comprises:
training, by the computing system, a reward model to generate a positive reward value for model outputs that reference the one or more capabilities of the machine-learned sequence processing model; and
performing, by the computing system, reinforcement learning on the machine-learned sequence processing model using the reward model.

7. The computer-implemented method of claim 6, wherein training, by the computing system, the reward model comprises training, by the computing system, the reward model on human feedback data that indicates a preference for model outputs that reference the one or more capabilities of the machine-learned sequence processing model.

8. The computer-implemented method of claim 1, further comprising:
processing, by the computing system, an input with the machine-learned sequence processing model to generate an additional output that references the one or more capabilities of the machine-learned sequence processing model;
observing, by the computing system, a user interaction with the additional output; and
further training, by the computing system, the machine-learned sequence processing model based on the user interaction.

9. The computer-implemented method of claim 1, further comprising:
identifying user-specific data associated with a plurality of users,
wherein training, by the computing system using the training example, the machine-learned sequence processing model comprises training, by the computing system using the training example, the machine-learned sequence processing model to generate the model output that references the one or more capabilities of the machine-learned sequence processing model corresponding to individual ones of the plurality of users.

10. A computing system, comprising:
one or more processors; and
one or more non-transitory computer-readable media that store instructions that, when executed by the one or more processors, cause the computing system to perform operations, the operations comprising:
processing, by the computing system, an input with a machine-learned sequence processing model to generate an initial model output;
determining, by the computing system, whether to modify the initial model output; and
in response to a determination to modify the initial model output: modifying, by the computing system, the initial model output to include one or more references to one or more capabilities of the machine-learned sequence processing model.

11. The computing system of claim 10, wherein determining, by the computing system, whether to modify the initial model output comprises
detecting, by the computing system, that the initial model output mentions one of a number of pre-determined external services; and
in response to said detecting: adding, by the computing system, additional content to the initial model output that references the one or more capabilities of the machine-learned sequence processing model relative to the one of the pre-determined external services.

12. The computing system of claim 10, wherein determining, by the computing system, whether to modify the initial model output comprises
detecting, by the computing system, that the initial model output mentions one of a plurality of different tasks; and
in response to said detecting: adding, by the computing system, additional content to the initial model output that references the one or more capabilities of the machine-learned sequence processing model relative to a different task that is hierarchically related to the one of the tasks mentioned in the initial model output.

13. The computing system of claim 10, wherein determining, by the computing system, whether to modify the initial model output comprises
detecting, by the computing system, that the initial model output mentions one or more tasks; and
in response to said detecting: adding, by the computing system, additional content to the initial model output that references the one or more capabilities of the machine-learned sequence processing model relative to one or more preferred input data features.

14. The computing system of claim 10, wherein the operations further comprise:
identifying user-specific data associated with a plurality of users, and
training, by the computing system using a training example, the machine-learned sequence processing model to generate the initial model output that references the one or more capabilities of the machine-learned sequence processing model corresponding to individual ones of the plurality of users.

15. One or more non-transitory computer-readable media that collectively store a machine-learned sequence processing model, the machine-learned sequence processing model having been trained by performance of training operations, the training operations comprising:
obtaining, by a computing system comprising one or more computing devices, a training example for training the machine-learned sequence processing model;
training, by the computing system using the training example, the machine-learned sequence processing model to generate a model output that references one or more capabilities of the machine-learned sequence processing model; and
storing, by the computing system, the machine-learned sequence processing model.

16. The one or more non-transitory computer-readable media of claim 15, the operations further comprising:
storing, by the computing system and for one or more tasks, one or both of a set of preferred input data features or a dataset of few-shot examples having the preferred input data features;
automatically constructing, by the computing system, the training example from an initial example output, wherein automatically constructing the training example comprises:
detecting, by the computing system, that the initial example output mentions or performs the one or more tasks; and
in response to said detecting: adding, by the computing system, additional content to the initial example output that references the preferred input data features.

17. A computer-implemented method, comprising:
obtaining, by a computing system comprising one or more computing devices, an input comprising a natural language inquiry;
analyzing, by the computing system, the natural language inquiry with a machine-learned model to output content based on the natural language inquiry;
analyzing, by the computing system, the content with the machine-learned model to output a trigger to showcase a capability of the machine-learned model, the content being interpreted as a catalyst to generate the trigger, the catalyst comprising an explicit catalyst associated with a focus of the content being showcasing or an implicit catalyst associated with the focus not being showcasing;
processing, by the computing system, the trigger with the machine-learned model to evoke an automated tutorial associated with a characteristic of the machine-learned model derived from deconstruction of the content; and
causing, by the computing system, presentation with a computing device of the automated tutorial.

18. The computer-implemented method of claim 17, further comprising:
analyzing, by the computing system, the content with the machine-learned model to identify a category associated with the content, the category comprising at least one of a first category associated with an external service identified in the content, a second category associated with a task of a level being below a level threshold, or a third category associated with information provided in the content not satisfying a requirement of an action associated with the catalyst.

19. The computer-implemented method of claim 17, wherein the explicit catalyst comprises a command or an inquiry associated with at least one of the automated tutorial or the capability of the machine-learned model.

20. The computer-implemented method of claim 17, wherein the implicit catalyst comprises a command or an inquiry not associated with any automated tutorial or any capability of the machine-learned model.
